(19) United States
(12) Patent Application Publication
(10) Pub. No.: US 2024/0175549 A1
(43) Pub. Date: May 30, 2024

(54) CONSTRUCTION FOR CARBON CAPTURE AND/OR STORAGE, METHOD FOR OPERATING THE CONSTRUC-TION AND MACHINE TO BUILD SAID CONSTRUCTION

(71) Applicant: Tobias Brett, Schönefeld (DE)

(72) Inventor: Tobias Brett, Schönefeld (DE)

(21) Appl. No.: 18/283,256

(22) PCT Filed: Mar. 23, 2022
(86) PCT No.: PCT/EP2022/057664

§ 371 Date: Sep. 21, 2023

(30) Foreign Application Priority Data
Mar. 23, 2021 (DE) 10 2021 107 272.7

(51) Int. Cl. F17C 11/00; B01D 53/14

(52) U.S. Cl. CPC F17C 11/00; B01D 53/1475; B01D 2257/504; F17C 2203/06

(57) ABSTRACT

Construction for carbon capture and/or storage, comprising a wall and/or pillar structure made from solid material pieces, carbon capturing material arranged in storage space between said solid material pieces, and a distribution system for controlled distribution of carbon capturing material and/or water into said storage space.

The present invention refers to a construction for carbon capture and/or storage, a construction machine for generating a construction, an arrangement of construction machines, a robot device for the operation of a construction, a system for carbon capture and/or storage, a method for generating a construction and a method for operating a construction and/or a system for carbon capture.

The Intergovernmental Panel on Climate Change (IPCC) describes the challenges imposed by climate change and list measures to fight climate change. One of the proposed solutions is the geoengineering method of enhanced weathering of natural rock. Geoengineering methods require massive investments, and will require massive governmental subsidies. Additionally, the geoengineering method of enhanced weathering results in large amount of material being spilled into the environment. It is known, for example, to crush and grind volcanic rock to small particles, e.g. to particles of about 20 micrometers. Thereby, the rock surface is increased by a factor of magnitude. The powder may then be spilled over land or the sea. The particles then start weathering. For example, the forsterite contained in volcanic rock may remove carbon from the ecosystem during its chemical dissolution process. The result are carbonates or hydro-carbonates, usually based on calcium or magnesium. However, volcanic rock may also contain heavy metals, such as nickel, and spilling grinded particles of such rock material over land or the sea also has a negative environmental impact.

It is therefore an object of the present invention to increase the safety of enhanced weathering, in particular reducing the reducing the risk of distributing heavy metals into the environment while conducting the method of enhanced weathering. It is furthermore an object of the present invention to enable enhanced weathering with little cost for input material and with reduced or zero output of waste material.

At least one of the above objectives has been solved with a construction for carbon capture and/or storage according to claim 1.

At least one of the above objectives has been solved with a construction machine according to claim 18.

At least one of the above objectives has been solved with an arrangement of construction machines according to claim 24.

At least one of the above objectives has been solved with a robot device according to claim 25.

At least one of the above objectives has been solved with a system for carbon capture and/or storage according to claim 30.

At least one of the above objectives has been solved with a method for generating a construction according to claim 33.

At least one of the above objectives has been solved with a method for operating a construction and/or a system for carbon capture according to claim 37.

Preferred embodiments of the present invention are subject to the dependent claims, and will be discussed hereinafter.

A construction for carbon capture and/or storage according to the present invention may particularly be a construction for capture and/or storage of CO₂ and/or a construction for direct air capture of carbon and/or CO₂.

A construction for carbon capture and/or storage according to the present invention may further particularly be a decentralized closed-loop direct air capture system.

According to the present invention, a construction may comprise a wall and/or pillar structure made from solid material pieces, carbon capturing material arranged in storage space between said solid material pieces, and a distribution system for controlled distribution of carbon capturing material and/or water into said storage space.

The carbon capture material is thus deployed within a wall and/or pillar structure and therefore spilling of the same into the environment may be avoided. The risk of environmental damages is thereby reduced, as also the uncontrolled deployment of heavy metals into the environment is avoided. At the same time, the construction as a geometrical structure may provide utility to the respective owner of a property. The construction may for example provide a protection or enclosure for a private property or land.

According to the present invention, the carbon capturing material may remove carbon, particularly CO₂, from the atmosphere and provide a permanent storage for the same. A positive impact to climate may therewith be ensured.

A construction according to the present invention may be provided at decentral locations, particularly many decentral locations and therefore at large scale. Significant impact on the climate may thus be achieved.

A construction according to the present invention may particularly be a wall and/or pillar structure, but is not limited thereto. A construction according to the present invention may generally refer to different types, forms and sizes of architectural structures. Particularly, a construction according to the present invention may be an enclosure for the yard of a property, such as a front yard and/or back yard.

According to a preferred embodiment, said carbon capturing material is configured for chemically absorbing carbon and/or carbon dioxide, in particular through exotherm reaction, and/or for mineral carbonation.

According to a further preferred embodiment, said carbon capturing material is configured for direct air captioning of carbon and/or carbon dioxide.

According to a further preferred embodiment, said carbon capturing material is and/or comprises a mineral containing Mg and/or Ca.

According to a yet further preferred embodiment, said carbon capturing material is and/or comprises basalt and/or dunite and/or olivine and/or pyroxene and/or pyroxenoid and/or forsterite and/or monticellite and/or wollastonite and/or diopsid and/or enstatite.

Such carbon capture materials have a high capability of capturing and permanently storing carbon from the air, and are also available in relatively large amounts.

According to a yet further preferred embodiment, said the wall and/or pillar structure comprises at least one string for jamming said solid material pieces, in particular a made of basalt fiber and/or coated basalt fiber. By jamming said solid material pieces, a so called Jammed Architectural Structure may be realized, which is highly stable and may also easily be disassembled by pulling out the string or fiber.

Such a Jammed Architectural Structure can be built without concrete. Such constructions may be made of stone fractions or crushed stones being jammed together by pressure and vibration or shaking process. The so called jamming effect may be increased by the use of a string, which may be unwound during the building process throughout the stone structure. The string can be replaced by basalt fiber. This material is made of natural rock. It may have a protective coating which prevents the fiber from weathering itself. The construction may be built in horizontal layers. Each layer may have a thickness of e.g. 1.5 cm of rock gravel. Between two layers, string may be deployed on the gravel.

According to a yet further preferred embodiment, the distribution system comprises a pipe and/or valves arranged on top and/or within a top portion of the wall and/or pillar structure and/or wherein the distribution system is configured for distributing carbon capture material, particularly rock powder and/or particles, together with a water stream throughout the wall and/or pillar structure and/or wherein the distribution system is configured for controlled distribution of carbon capturing material and/or water within selected segments of the wall and/or pillar structure. The distribution system may be arranged on a top wall portion below a cover plate or the like. The distribution system may for example be a pipe with valves, particularly a plurality of valves, each arranged on top of or within the top portion of a wall section.

Via such distribution system, carbon capture material, such as volcanic rock powder or particles, can be supplied to any wall segment. For example, the proportion of volcanic rock particles can be adjusted and in that one valve per wall segment of, for example, one, for example 2, for example three or 20 meters in length can be opened or closed and volcanic rock particles can be discharged via the supply system. Dependent on the conditions in the respective wall or pillar segment, a specific supply may be ensured.

According to a yet further preferred embodiment, the distribution system comprises at least one pipe, filling opening and/or tank for filling rock particles, preferably grinded rock particles, and/or a slurry and/or gel and/or glue material with rock material, more preferably for filling rock particles from basalt and/or dunite and/or olivine and/or pyroxene and/or pyroxenoid and/or forsterite and/or monticellite and/or wollastonite and/or diopsid and/or enstatite.

The input for fresh rock powder or fresh carbon capture material may be performed by injection of powder or material into a water pipe on top of the wall or in a top portion of the wall, which may also moisture the entire wall or moisture the storage space between said solid material pieces.

According to a yet further preferred embodiment, the construction may further comprise a drainage system for controlled drainage of water and/or weathered carbon capturing material out of said storage space and/or out of said wall and/or pillar structure.

According to a yet further preferred embodiment, said drainage system preferably comprises a basin and/or reservoir below the said wall and/or pillar structure and/or a pipe for conveying water and/or weathered carbon capturing material out of said basin and/or reservoir. Furthermore, water may be collected in the foundation of the wall and/or pillar structure and discharged through a drainage hose.

In other words, the construction may be operated through activation and/or deactivation of pipes on top of the wall or pillar structure and in the foundation of the wall and/or pillar structure. To optimize operation of the construction, an robot device, as described below, preferably an autonomous robot device may supervise the construction and deliver all obtained data to a cloud system or an Internet of Things operating system. The robot may apply computer vision, moisture sensors and sensors for the pH value of water to monitor the condition of the construction.

According to a yet further preferred embodiment, the construction may further comprise at least one receptacle, preferably a plurality of receptacles, for the controlled transformation of weathered carbon capturing material into construction material.

Accordingly, the construction may have low cost for input material and generate zero output of waste material, but instead material for further construction or enhancement of said construction may be generated such as in a circular economy for construction material.

In other words, the construction having for example volcanic rock material as input and no output. Volcanic rock would be exposed to air, water and sunlight and therefore start weathering and absorb carbon from the atmosphere. Due to the lack of an output for material, the system would grow in size. The geometrical structure of the whole system provides utility to its owner. Therefore, the system serves the purpose of being a dry rock wall. Applications for dry walls are protection of arable land or private ground.

The construction, including the generation of additional construction material, may be operated on a high level of autonomy, particularly in connection with a robot device as further described below.

Mineralized material may be taken or its removal initiated by the robot device and mixed together with sand and bacteria and preferably placed in receptacles on the top plate of the wall or pillar, and the bacteria may form concrete therefrom and the robot takes out the concrete molds after a few days.

According to a yet further preferred embodiment, the at least one receptacle is provided within a shell and/or within and/or on a top portion of the wall and/or pillar structure and/or wherein the receptacle is accessible from the top of the wall and/or pillar structure and/or comprises a cover and/or lid, which may be removable for access to the interior of the receptacle.

According to a yet further preferred embodiment, the receptacle may be configured for controlled transformation of weathered carbon capturing material into brick and/or gravel material and/or solid material pieces for construction purposes.

Furthermore, the receptacles may be configured for generating material in the form of crushed stone. The robot device, as described below, may build new wall segments with the new crushed stone material.

Furthermore, the receptacles may be configured for generating facade claddings for buildings or other parts for the construction industry.

According to a yet further preferred embodiment, the construction further comprises a transfer system for transferring water and/or weathered carbon capturing material out of a basin and/or reservoir below the wall and/or pillar structure into said receptacle and/or for transferring water and/or weathered carbon capturing material out of storage space directly into a receptacle for controlled transformation of weathered carbon capturing material into construction material. The transfer system may at least in sections be provided by the supply system or use said supply system.

According to a yet further preferred embodiment, the construction further comprises a fouling and/or gassing device, in particular a fouling and/or gassing pipe, for the controlled fouling of biological material and/or the production of CO2, which may escape into water for moisturizing the wall and/or into water for filling of a receptacle for construction material and/or wherein the released CO2 from the fouling and/or gassing device is configured to form carbonic acid within the respective water.

Carbonic acid can be introduced into the water in a controlled manner by generating said fouling gases, for example in the top plate of the wall structure by a biological processes. CO₂ may then escape into the water and carbonic acid to form in the water.

Furthermore, the carbonates may be precipitated out of the water again by lowering the carbonic acid content, for example by swirling water. The lowering of the carbonic acid content may be required for the transformation of weathered carbon capturing material into brick and/or gravel material and/or solid material pieces for construction purposes.

A further aspect of the present invention refers to a construction, preferably according to any one of the preceding aspects, comprising solid material pieces and a string for jamming said solid material pieces, wherein at least some of the solid material pieces are made from basalt and/or dunite and/or olivine material and/or are at least section wise covered by basalt material and/or dunite and/or olivine material, and wherein a supporting portion made of said solid material pieces and/or a top cover portion covering said supporting portion comprises at least one pipe, filling opening and/or tank for filling rock particles, preferably grinded rock particles and/or rock particles from basalt and/or dunite and/or olivine material, and/or a slurry and/or gel and/or glue material with rock material, more preferably for filling rock particles from basalt and/or dunite and/or olivine.

According to a yet further preferred embodiment, the at least one pipe, filling opening and/or tank may be configured for filling rock particles at an upper portion of the supporting portion and/or a covering portion and/or a top cover portion and/or for distributing the rock particles, particularly rock particles from basalt and/or dunite and/or olivine, throughout the supporting portion and/or the covering portion by a stream of liquid, preferably water.

A further aspect of the present invention refers to a construction machine for generating a construction according to any one of the preceding aspects and/or embodiments. A construction machine according to the present invention may comprise a supply system for continuously supplying solid bulk material to a construction site while driving and/or moving along a predefined path.

A construction machine according to the present invention allows to build or generate a construction such as a wall and/or pillar structure in a particularly efficient and fast process. Large constructions may be deployed in only little time and with only little costs.

According to a yet further preferred embodiment, the machine and/or its supply system may be configured to continuously supply a layer of solid bulk material to a construction site along a path with a length of at least 5 m, preferably at least 10 m or at least 20 m or at least 50 m or at least 100 m before reverting the moving and/or driving direction for applying a next layer of solid bulk material.

In other words, for low cost purpose, the construction machine may deploy the wall or pillar structure at a constant feed rate with no or only little interruption. Each turning point of the machine may interrupt the feeding of solid bulk material. Therefore the machine may preferably build a long path along a perimeter at once and without interruption. Such concept of wall building shall be named “line production” in this document.

According to a yet further preferred embodiment, the supply system may comprise a sheet ramp, particularly a metal sheet ramp, with a predefined widths for controlled guiding of solid bulk material to a construction site, wherein the sheet ramp is exchangeable for generating wall and/or pillar structures with different widths or dimensions and/or wherein the sheet ramp is equipped with obstacles placed on the path for the solid bulk material to improve a uniform distribution of said solid bulk material in widths-direction on the ramp and subsequently on the construction site.

Thus, such metal sheet ramp may be used to provide a constant and ongoing feed of gravel or solid bulk material onto a previous layer of gravel or solid bulk material and/or on a string or basalt fiber, as described below. Some obstacles may be placed on the metal sheet ramp to improve a uniform distribution of gravel or solid bulk material in a y-direction on the ramp and then on the wall.

In a preferred solution, the metal sheet ramp may be filled with gravel or solid material pieces by blasting through a pipe. Blasting of construction material from a truck through a pipe may be conducted at high rates.

In another preferred solution, the gravel and/or solid material pieces may be contained in a container nearby being poured onto the metal sheep ramp.

To reduce dust formation, the gravel and/or solid material pieces may be exposed to water or to a rock powder slurry.

According to a yet further preferred embodiment, the construction machine may further comprise a feeding system for feeding a string and/or a basalt fiber onto a construction site for a wall and/or pillar structure and/or onto already supplied solid bulk material for jamming said solid bulk material. Therewith, the string and/or basalt fiber may be provided to the wall or pillar structure to be built at high rates.

According to a yet further preferred embodiment, the feeding system may comprise a guiding device for a string and/or basalt fiber, preferably a guiding pipe, wherein the distal end of said guiding device is free of any driving unit for said string or basalt fiber and/or wherein the string or basalt fiber is pushed into said guiding device, preferably at a defined speed and/or a controlled speed and/or by means of an airstream and/or stream of water and/or stream of slurry.

According to a further preferred solution, the basalt fiber or string may be deployed through one pipe or two pipes or multiple pipes. Preferably, there is no motor at the end of the pipe, the end of the pipe is free of any motor to pull the fiber or string out of the pipe. The end of the pipe may be heavily exposed to abrasive rock dust and therefore affect the functionality of such motor. Instead, the fiber or string may be pushed into the pipe system at a defined speed or a controlled speed.

In another preferred solution, a stream of water runs at a higher speed through the pipe or guiding device than the speed of the fiber or the string. The water stream may even be mixed with rock particles at a predefined concentration of more than 10% or more than 20% or more than 30% or less than 50%.

In a further preferred solution, the concentration of rock powder may be as high as 80% or 90% or higher and the fluid may be a slurry. The slurry may help to attach gravel or solid material pieces to the fiber, wen deployed. This may be beneficial during the build process. The jamming effect within Jammed Architectural Structures requires pressure, but during the build process, there are no layers on top to weigh on and enable the jamming effect. Therefore, a slurry may help to prevent gravel or solid bulk material from dropping on the side of the wall or unfinished structure. If dropping of gravel or solid material pieces would be reduced by e.g. 50% or 70%, the build process may be stabilized and a stabile production quality may be ensured.

In a further preferred solution, even pure water may improves the process as wet fiber will lay down on the gravel or solid material pieces and stick to gravel without being removed by wind or other air streams.

In another solution, a lubricant is applied to support the transport of fiber through the pipe. In another solution, an air stream may be configured to support the transport of the fiber and/or string out of deploying pipe and/or onto the gravel or solid material pieces.

The side of the pipe or guiding device where the fiber or string may be pushed out of the pipe may be targeted towards the top side of the wall in x-direction. An effector my be used to direct the deployment of fiber or string in Y-direction, namely in direction transverse a feeding direction.

In a further preferred solution, two or three or four fibers or strings are may be deployed by the construction machine from two or three or four or even more pipes. Each fiber or string deployer may create a sinus formation with fiber or string on the top of the wall or unfinished construction. The strings or fibers may be laid one to another, but preferably not in phase to each other.

According to a yet further preferred embodiment, the construction machine may further comprise a compacting device for compacting the solid bulk material deposited on a construction site and/or on layers of solid bulk material already deposited, wherein said compacting device is preferably configured as a rolling and/or stamping device and/or vibrating device and/or wherein the compacting device is exchangeable for different construction widths or dimensions.

Thus, the fresh gravel or solid bulk material may become packed tightly. This may be achieved by a device compacting device. In a preferred solution, the compacting device may also be used to mechanically adjust the distance of the machine or a machine head to the wall or unfinished construction in an x-direction, thus in feeding direction of the solid bulk material and/or a feeding direction of a string or fiber. In a further preferred solution, a roller is applied as a compacting device. In an alternative solution, a stamper may be applied as a compacting device. The stamper may vibrate to facilitate the packing of gravel or solid bulk material.

A further aspect of the present invention refers to an arrangement of construction machines, preferably of construction machines according to any one of the preceding aspects and/or embodiments, wherein each construction machine may be configured for the execution of a different construction process. Preferably at least one construction machine may be configured for the supply of solid bulk material, the same or another construction machine may be configured for the feeding of a string or a basalt fiber and/or a different construction machine may be configured for the compacting of the solid bulk material.

Each process step, the laying of fiber, the feeding of gravel and the packing of gravel can be performed on a separate mobile platform device, such as a mobile mover an autonomous vehicle or a tractor, or they can be built into one single construction machine.

The thickness of a wall or pillar construction to be build can be adjusted preferably by simple modifications on the construction machine. The metal sheet ramp may be exchanged through a wider one or a more narrow one. The effector of the pipes or guiding devices may also be adjusted accordingly. Furthermore, also the compacting device, such as the roller or stamper, may be exchanged.

A yet further aspect of the present invention refers to a robot device for the operation of a construction according to the preceding aspects and/or embodiments, comprising at least one sensor for measuring at least one condition of the construction, preferably for measuring at least one condition of the wall and/or pillar structure and/or carbon capturing material within the storage space between said solid material pieces and/or for measuring at least one condition within at least one pipe and/or receptacle and/or basin below the wall and/or pillar structure, and/or a processing unit for processing data, preferably data referring to a measured condition, and/or at least one interface for transmitting data, preferably data referring to a measured condition.

According to a further preferred embodiment, the sensor may be configured to measure a moisture level and/or a weathering degree of carbon capturing material and/or wherein the processing unit and/or the interface is configured for initiating a moistening process and/or for optimizing or initiating an optimization of a weathering process of carbon capturing material and/or the removing of weathered carbon capturing material from the wall and/or pillar structure, preferably by a stream of water and/or preferably based on a measuring result of at least one sensor.

According to a yet further preferred embodiment, the processing unit and/or the interface may be configured for initiating the supply of weathered carbon capturing material to a receptacle for the controlled transformation of weathered carbon capturing material into construction material, preferably based on a measuring result of at least one sensor. In particular, the processing unit may process and/or generate data and said data may be transmitted via the interface for initiating further processes.

According to a yet further preferred embodiment, the processing unit and/or the interface may be configured for initiating the distribution of unweathered or fresh carbon capturing material into storage space between said solid material pieces, preferably based on a measuring result of at least one sensor.

According to a further preferred embodiment, the robot device may be a mobile robot device and/or monitor the parameters of humidity, temperature and particle quantity by means of sensor rods, which it may preferably insert into wall and/or pillar segments.

Preferably, the robot device may control the water supply and/or drainage system and may thus optimize the supply of water, particles, such as carbon capture material, and/or carbonic acid.

Preferably, either particles may be deposited in the wall by supplying a lot of particles when there is little water, or the wall may only moistened on the inside, or particles may be flushed out of the wall by greatly increasing the carbonic acid content when there is a lot of water, in order to dissolve carbonates from the wall in the water.

According to a yet further preferred embodiment, the processing unit and/or the interface may be configured for initiating the removal of finished construction material from a receptacle. In particular, the processing unit may process and/or generate data and said data may be used and/or transmitted via the interface for initiating further processes for the removal finished construction material from a receptacle.

According to a yet further preferred embodiment, the robot device itself may be configured for removal of finished construction material from a receptacle, particularly by use of a gripping device or end-effector.

As described above, the output of weathered carbon capture material will occur through shells or receptacles. The robot device may be programmed to remove new construction material from these shells or receptacles. Therefore, it will open the shells or receptacles and remove the respective new part from its shell or receptacle and/or add it to a logistics container, such as a big bag.

According to a yet further preferred embodiment, the robot device may be configured to grow concrete-forming bacteria on or at the construction site and/or in close proximity of the construction, particularly in a biological reactor.

According to a yet further preferred embodiment, the robot device may be fully autonomous and/or all functions of the robot device may be executed fully or at least partly autonomous.

A yet further aspect of the present invention refers to a system for carbon capture and/or storage, comprising a construction according to any one of the preceding aspects and/or embodiments and at least one robot device according to any one of the preceding aspects and/or embodiments.

According to a yet further preferred embodiment, the system may further comprise an actuation device for activating and/or deactivating the distribution system for controlled distribution of carbon capturing material and/or water into said storage space and/or an actuation device for activating and/or deactivating the drainage system for controlled drainage of water and/or weathered carbon capturing material out of said storage space and/or out of said wall and/or pillar structure.

According to a yet further preferred embodiment, the system may further comprise an operating system, preferably an Internet of Things operating system and/or a cloud based operating system and/or wherein the robot device is connected to an Internet of Things operating system and/or a cloud based operating system and/or autonomous.

A yet further aspect of the present invention refers to a method for generating a construction, preferably a construction according to any one of the preceding aspects and/or embodiments, the method comprising the steps of: providing a construction machine to a construction site, continuously supplying a layer of solid bulk material to a construction site by said construction machine while driving and/or moving said construction machine along a predefined path, and repeating the continuous supply of solid bulk material onto the previous layer in order to generate a further layer.

According to a preferred embodiment, the moving and/or driving direction of the construction machine is reverted before the next layer of solid material pieces is supplied.

According to a further preferred embodiment, a string and/or basalt fiber is fed onto already supplied solid bulk material for jamming said solid bulk material and/or wherein a plurality of strings and/or basalt fibers are fed onto already supplied solid bulk material for jamming said solid bulk material.

According to a yet further preferred embodiment, a string and/or basalt fiber may be deployed by an effector in a back and forth manner, preferably in a sinus formation crosswise to the feeding direction, and/or wherein a plurality of strings and/or basalt fibers may be deployed by an effector in a back and forth manner and/or on top of each other, preferably in a sinus formation crosswise to the feeding direction and/or in a sinus formation out of phase to each other.

A yet further aspect of the present invention refers to a method for operation of a construction according to any one of the preceding aspects and/or embodiments and/or for operation of a system for carbon capture and/or storage according to any one of the preceding aspects and/or embodiments, wherein at least one condition of the construction is measured by a sensor and/or at least one action, preferably a moistening action, draining action carbon capture material removal and/or distribution action is initiated dependent on the at least one measurement result of the sensor.

A yet further aspect of the present invention refers to a method for the production of construction material, the method comprising the steps of: weathering carbon capture material within a wall and/or pillar structure, particularly within storage space between solid material pieces of a wall and/or pillar structure; removing weathered carbon capture material from the wall and/or pillar structure, preferably by a stream of water; supplying said removed and weathered carbon capture material together with water to a receptacle within, adjacent or in proximity of said wall and/or pillar structure; and transforming the weathered carbon capture material within said receptacles to construction material.

Transformation of weathered carbon capture material may comprise a process to generate new building material out of rock powder. By weathering, water may become enriched with calcium carbonate (CaCo₃), magnesium carbonate and many further elements.

A preferred aspect of transformation may be the control of precipitation of carbonates, such as CaCo₃. Precipitation should preferably not occur unintended inside of any pipes or supply devices or other elements of the wall structure, as this will block the function of the system over time. Instead, precipitation shall be fostered inside of shells or receptacles with predefined geometries, according to the intended geometry of the construction material.

In a preferred solution, precipitation may be controlled by the amount of carbonic acid in the water. Reduction of carbonic acid may preferably be achieved right before the water enters a shell or receptacle, by turbulences generated by mixing water and air, e.g. with a swirler and a motor.

Furthermore, precipitation of carbonates, such as CaCo₃, may be fostered by an increase of water temperature, such as by sunlight.

In another preferred solution, precipitation may be controlled by reduction of vaporization of water, which affects the concentration of carbonates. In another solution, precipitation may be controlled by adding any chemical element, which affects the pH value of the water.

According to another preferred solution, precipitation may be fostered by the availability of crystal nucleation sites in the shell. This may be achieved by adding crystal nucleation particles to the water. And it can be achieved by the inner surface of the shell being a crystal nucleation site, itself.

According to a further preferred solution takes benefit of several of the solutions described before.

In a further preferred solution, fouling bacteria may be applied to generate CO₂ in a pipe on top of the wall or pillar structure. Due to the heat from sun radiation, the fouling process may be supported. A robot device may control the fouling process and/or add nutrition to the fouling process. Furthermore, CO₂ will saturate the fouling pipe and then start to create pressure on said pipe through gasification. The gas may then be released through a vessel and/or added to other pipes on top of the wall or pillar. One of these pipes may the one leading to shells and/or receptacles. By adding CO₂ to this pipe under pressure, carbonic acid may be obtained in the water and enable precise control on precipitation.

In order to foster fast growth, crystal nucleation particles may be added to the water. Particles may start to form inside of the shell or receptacle chamber which are similar to a sand structure. To this sand structure in the shells or receptacle, a process of biomineralization may be applied.

To accomplish a homogenous precipitation, a two-phase injection procedure may be conducted. In such a procedure a mixture of bacteria and nutrients may firstly injected into the material, immediately followed by a fixation solution (i.e. a solution with high salt concentration). The fixation solution may be applied to control the distribution of cells on grains to assure their in-depth penetration and uniform attachment. Finally, this stage may be followed by the injection of urea-Ca2+ solution to effectuate the precipitation. When sufficient calcium carbonate is precipitated, durable stabilization of the material may be achieved.”

A preferred bacterium utilized in this method may be the soil bacterium Sporosarcina pasteurii (formerly Bacillus pasteurii) or alternatively direct application of the purified enzyme that may be extracted from plant sources, mainly from jack bean. Normally, the production of highly active ureolytic bacteria on larger scale may be expensive, representing a major cost factor in the precipitation process.

But for the present invention, an autonomous robot may be supervising the site and/or control the production of bacteria on-site, which may reduce cost.

Biomineralization or the free enzyme procedure may be applied to interconnect the sandy structure of precipitated carbonates and heavy metal residues in the shell or receptacle to form a solid object inside of the shell or receptacle, and therewith finally generate new construction material.

In a further preferred solution, the shells and/or receptacles may be applied to produce new gravel and/or construction material pieces and/or to produce decorative stones, which can be applied on the outer side of walls (outer compound).

According to a further preferred embodiment of the construction, wall and/or pillar structure, a micro filtration device may be provided. Such micro filtration device may be provided for filtering rock grains below a size of 50 micrometers, below a size of 30 micrometers or below a size of 20 micrometers. Such very fine rock grain may be contained in the carbon capturing material arranged in the storage space between said solid material pieces, in particular in a carbon capturing material provided in the form of a rock slurry. The micro filtration device may provide a filter functionality for water and/or weathered carbon capturing material received by the drainage system of the construction, in particular by a basin or reservoir below the said wall and/or pillar structure. Additionally or alternatively, the micro filtration device may provide a filter functionality for water and/or weathered carbon capturing material conveyed out of said basin and/or reservoir, particularly conveyed through a pipe.

According to a further preferred embodiment the construction, wall and/or pillar structure, may comprise a methane filtration device and/or a ventilation device for conveying methane gas to a methane filtration device. It is possible that gas streams containing biogenic CO₂ will contain methane, for example up to 4% methane or up to 2% methane or up to 0.2% methane. Such methane could mix into the process water of the construction and may gas out inside of the construction and/or be relieved into the atmosphere. Emissions of such methane should, however, be avoided.

A ventilation device may convey methane gas by soaking the methane gas out of the construction, wall and/or pillar system and feeding it into a methane filtration device. Such a methane filtration device could for example be arranged as an external system or, more favorable, be located within or on top of the construction. In particular, such methane filtration device may, for example, be arranged on top of each wall and/or pillar segment or at least on one wall and/or pillar segment.

It may particularly be beneficial to oxidize methane in a bio-filtration device, especially on top of the respective wall and/or pillar segment. For that, relatively dry soil may be kept in a receptacle on top of the wall and/or pillar structure or segment. Methane may be oxidized by bacteria in that soil and the methane concentration fosters the growth of these bacteria, particularly in case sufficient oxygen is provided, for example by an active ventilation device for the supply of oxygen.

According to a yet further preferred embodiment of the construction, the wall and/or pillar structure is configured for growth and/or development of construction material in storage spaces between said solid material pieces. According to a preferred embodiment of the method for operating the construction, construction material may be grown and/or developed in storage spaces between said solid material pieces.

The growth and/or development of construction material in storage spaces between said solid material pieces may be fostered by large surfaces, around which precipitation may take place. Such large surfaces may be provided by surface increasing objects, in particularly arranged between said solid material pieces and/or instead of said solid material pieces.

Surface increasing objects may, for example, be made of a wire mesh, in particular, a compacted wire mesh. Such wire mesh or compacted wire mesh may have a size comparable or similar to the size of one of the solid material pieces. Precipitation may form around such surface increasing object and therewith contribute to the generation of new construction material. Alternatively or additionally, a surface increasing object may be made from a foam, in particular a foam of basalt fiber.

According to a preferred embodiment of the method for operating the construction, the solid material pieces may be replaced, at least partly replaced, by surface increasing objects, in particular wire mesh and/or compacted wire mesh and/or foam and/or foam of basalt fiber. That is, said solid material pieces may subsequently be replaced by such surface increasing objects throughout the operation of said construction.

According to a particularly preferred embodiment, the solid material pieces may be completely replaced by surface increasing objects, in particular surface increasing objects for the growth and/or generation of construction material. In case said solid material pieces are partly replaced or completely replaced, it may be prevented that the surface increasing objects, such as a foam, is compressed by the weight of said solid material pieces.

According to a further preferred embodiment of the method for operating the construction and/or the construction, a formwork is provided at least section wise around the core of the wall and/or pillar structure. Said formwork may be provided as new construction material grown and/or developed by precipitation within and/or adjacent to the wall and/or pillar structure. By providing such formwork, the core of said wall and/or pillar structure may be free of any solid material pieces or at least the amount of solid material pieces may be reduced.

The space within such formwork may particularly be used for the growth and/or generation of new construction material. Accordingly, surface increasing objections may by arranged in a storage space enclosed by said formwork or between portions of said formwork. The storage space enclosed by said formwork may be used for the growth and/or development of construction material in an improved manner.

A further independent aspect of the present invention refers to a construction for carbon capture and/or storage, comprising a wall and/or pillar structure made from a formwork, and surface increasing objects arranged in a storage space at least section wise enclosed by said formwork. Preferably, an according construction may also comprise a distribution system for controlled distribution of water into said storage space enclosed by said formwork and/or for controlled PH cycling of water.

Furthermore, carbon capturing material may preferably be arranged within said storage space enclosed by said formwork. Furthermore, a distribution system for controlled distribution of water into said storage space enclosed by said formwork may be provided.

According to a further preferred embodiment, such formwork may be provided in addition to a covering portion within the meaning of the present teaching. In particular, a covering portion within the meaning of the present invention may also cover the formwork and/or be attached to said formwork.

According to a yet further preferred embodiment of the construction, the wall and/or pillar structure may have different sections for different phases of pH cycling, and/or different wall and/or pillar structures for different phases of pH cycling. Such different sections of said wall and/or pillar structures or different wall and/or pillar structures may be arranged adjacent to each other along a horizontal direction and/or along a length direction of the construction.

Preferably, at least one section of said wall and/or pillar structure may be configured free of carbon capture material or substantially free of carbon capture material. It is also possible that two different sections of said wall and/or pillar structure comprise different amounts of carbon capture material. By providing a section of said wall and/or pillar structure without or with a reduced amount of carbon capture material particularly facilitates the implementation of pH cycling.

According to a further preferred embodiment of the method for operation the construction, a flue-gas carbon removal may be conducted.

In a first step, flue-gas may dissolved in water. Such dissolving of flue-gas in water may be conducted outside or within the construction, wall and/or pillar structure.

In a second step, water with flue-gas dissolved therein or may be conveyed to a first wall and/or pillar section containing carbon capture material, for example in the form of a rock slurry. The water may be rinsed through said wall and/or pillar section containing carbon capture material.

When enriched with carbonates, the CO₂ may, in a third step, be removed by a vacuum and/or ventilation device, which may soaks the CO₂ out of the water enriched with carbonates. Accordingly, the construction may comprise and/or be connected a vacuum and/or ventilation device for removing and/or soaking CO₂ out of water.

In a fourth step, said water—with removed CO₂ or reduced amount of CO₂—may be conveyed to a second wall and/or pillar section being free or substantially free of carbon capture material, and rinsed there through. Carbonates may precipitate when rinsing through said second wall section.

In this second section being free or substantially free of carbon capturing material, PH cycling may be conducted, for example on a daily basis and/or in order to foster the formation of magnesite and/or hydromagnesite and/or aragonite and/or dolomite.

According to a further preferred embodiment of the method for operation the construction, pH cycling may comprise the fostering of precipitation by changing the pH value in the respective precipitation location within the construction, wall and/or pillar structure, preferably on a daily basis. PH cycling may foster the formation of hydromagnesit and/or magnesit. Both are suitable elements for the of construction material gravel to build further walls.

By changing the pH Value in a precipitation location or by conducting the so called pH cycling, metastable carbonates precipitated earlier in a precipitation location may again be removed and only stable carbonates precipitated earlier may remain in the respective precipitation location. The removing of metastable carbonates may, for example, be conducted with water, into which flue-gas has been dissolved. Rinsing said water through a second wall and/or pillar section being free of substantially free of carbon capture material may sufficiently dissolve metastable carbonates and stable carbonates may remain.

After metastable carbonates precipitated earlier in a precipitation location have been dissolved, again water enriched with carbonates and from which CO₂ has been removed or soaked out, may be rinsed through said second wall and/or pillar section for precipitation of carbonates. The amount of stable carbonates precipitated in the respective precipitation location is increased and growth or development of construction material may be fostered.

According to a further preferred embodiment of the method for operation the construction, pH cycling may be conducted by the employment of zinc ions. Zinc concentration in the water may therefore be changed, for example, twice a day. The zinc concentration may substantially affect the pH value of the water and therefore facilitate the conducting of pH cycling.

According to a further preferred embodiment, the construction may comprise an appliance room and/or an appliance facility. Such appliance room and/or an appliance facility may be provided adjacent and/or at a distance from the wall and/or pillar structure. Within such appliance room and/or an appliance facility at least one appliance of said construction may be arranged, for example, a water pump, water valves, filtration device, such as a micro filtration device and/or a methane filtration device, and/or a vacuum and/or ventilation device for the removal of CO₂ out of water and/or control device for controlling the operation of the construction.

The details and/or advantages described above with regard to the construction, the machine for generating a construction, the arrangement of construction machines, the robot device for the operation of a construction, the system for carbon capture and/or storage likewise apply to the method for generating a construction and/or the method for operating a construction and/or a system for carbon capture and/or the method for the production of construction material and/or vice versa.

The details and/or advantages described above with regard to the construction likewise apply to the machine for generating a construction, the arrangement of construction machines, and/or the robot device for the operation of a construction, the system for carbon capture and/or storage.

Further aspects and embodiments of the present invention, in particular with regard to a construction, wall and/or pillar structure, are described in the first supplement description hereinafter. All features or feature combinations of the aspects and embodiments described in the supplement description below may be combined with the aspects and embodiments described above or specified in the claims of the present application.

A construction according to an aspect of the present invention may comprise a supporting portion and a covering portion for covering the supporting portion, the supporting portion being provided by solid material pieces and at least one string for jamming at least some of the solid material pieces. According to the present invention, the covering portion may comprise at least one covering device, wherein the string and the covering device may be attached to each other.

The supporting portion itself may already provide a certain degree of mechanical stability due to the jamming effect, which may particularly be enhanced due to the use of a string. Now, by providing a covering portion with at least one covering device, the outer appearance of the construction may be improved. The string and/or the solid material pieces of the supporting portion may be suitably covered by the covering portion, and therefore less visible or entirely covered.

At the same time, the providing of the covering portion and the attachment of the at least one covering device to the string, allows to further improve the mechanical properties and durability of the construction. The covering portion with the at least one covering device may further enhance the jamming effect within the supporting structure, and particularly prevent single solid material pieces to break out or detach out of the supporting portion. Accordingly, it may also be avoided that loose string portions would hang out of the construction. This reduces the risk of unintended deteriorations or disassembly processes. Due to the attachment of the string with the at least one covering device, the covering device may be suitably held in place and also provide holding support for at least some of the solid material pieces of the supporting structure.

According to the present invention, the term “string” is not limited to textile, synthetic or metallic strings, but may refer to every kind of elongated flexible attachment means. For example, a “string” within the meaning of the present invention may likewise refer to a flexible cable, chain, belt, and/or strap, synthetic fibre or carbon fibre strings, or the like.

According to a preferred embodiment of the present invention, the construction may be a dry construction, particularly a dry wall system or dry pillar system. The assembly or generation process may therewith be facilitated as no water adding and drying steps are required.

According to a further preferred embodiment, may be configured for disassembly, at least for part-disassembling, by pulling out the string of the supporting portion. In particular, the construction may be configured for disassembly by reversing the assembly process. The quality and/or usability of the single construction components may therefore be maintained also after disassembly. Furthermore, disassembly may be favourable if cleaning the construction does not compensate aging effects, e.g. cleaning equipment does not reach into gaps or pores of solid material pieces or covering devices. Disassembly can then enable individual cleaning of each component until the aging effects are suitably removed.

According to a further preferred embodiment, the supporting portion and/or covering portion may be arranged and/or assembled on soil ground and/or grassland. Also, the supporting portion and/or covering portion may be configured for self-restructuring, particularly in case of ground movements, such as movements due to frost and/or heavy rain. In case of large displacements with unfavourable optical effects, the respective construction segment may be disassembled and rebuild.

Furthermore, the supporting portion and/or covering portion may at least section wise be arranged and/or assembled within soil ground and/or below the ground surface and/or within a hole in soil ground, preferably below the frost line. Therewith, the construction may replace a basement or groundwork of an architectural structure, particularly in case of intense ground movements.

According to a further preferred embodiment, the supporting portion and/or covering portion may be configured for automated and/or manual generation, assembly and/or disassembly and/or for the generation, assembly and/or disassembly with robot equipment.

According to a further preferred embodiment, the covering portion is arranged around the supporting portion and/or on a plurality of sides of the supporting portion. The covering portion may provide a cast for the supporting portion, particularly a cast for a compound of the solid material pieces and the string of the supporting portion. The mechanical properties and durability of the construction as well as the outer appearance may thereby be further improved. By providing a cast, the building of the supporting structure may furthermore be facilitated.

According to a yet further preferred embodiment, the at least one covering device may be made from a different material and/or may have a different optical appearance than at least some of the solid material pieces of the supporting structure. The covering device may accordingly be chosen in view of appearance criteria.

The at least one covering device may have a larger size than the average solid material piece of the supporting structure. The at least one covering device may accordingly have an improved holding functionality or cast functionality for the solid material pieces of the supporting portion.

Furthermore, the at least one covering device may have a rounded shape and/or be free of edges or sharp portions. The covering device may therefore also be made from a material and/or have a shape being unsuitable for jamming.

According to a yet further preferred embodiment, the solid material pieces may be provided as crushed rocks, angular rocks, granular stone material and/or broken stones. Such material may be provided with only little costs and has a high durability. It is also possible that the solid material pieces may be provided as glass material and/or glass gravel and/or glass chippings. This may prove beneficial for illumination purposes.

According to a yet further preferred embodiment, the solid material pieces may be jammed and/or stamped and/or compressed, preferably for increasing a jamming effect. The stability of the supporting portion may thereby be further improved.

According to a yet further preferred embodiment, the string is at least section wise laid within and/or throughout the supporting portion and/or between the solid material pieces and/or loosely laid and/or at least section wise tightened, preferably for increasing a jamming effect. Thereby, the mechanical properties and durability of the supporting portion may further be enhanced.

It is furthermore possible that the string is arranged in a pattern alternatingly running between a central area of the supporting portion and different covering devices. The contribution of the string to the jamming effect within the supporting portion may thereby be further improved.

Preferably the string is at least section wise laid within and/or throughout the supporting portion in a non-linear fashion and/or at least section wise in a curved fashion and/or bended or curved at least section wise around the solid material pieces.

Likewise it is possible that string is flexible and/or limp in a non-tensioned state and/or wherein the string remains at least section wise curved and/or bended in a tensioned state in order to provide and/or improve a jamming effect.

According to a yet further preferred embodiment, the covering portion may comprise a plurality of covering devices, preferably arranged adjacent to each other and/or along and/or adjacent to the supporting portion. A larger surface may thereby be covered and/or a larger cast for the supporting portion be provided.

The string may be attached to a plurality of covering devices, preferably to a plurality of covering devices on different sides of the supporting portion. The overall stability of the construction may be further improved in this manner.

According to a yet further preferred embodiment, the at least one covering device may be made of and/or comprises a stone and/or glass and/or metal material.

Such materials may provide an aesthetic appearance, while at the same time allowing a sufficient holding functionality for the supporting portion, particularly a stable cast for the supporting portion.

According to a yet further preferred embodiment, the at least one covering device may comprise a visible side facing away from the supporting portion and/or a functional side facing the supporting portion, wherein the string is attached to the covering device at the functional side. The functional side may therefore be specifically designed for the attachment of the string, and the visible side be designed or provided for an improved or high quality appearance.

According to a yet further preferred embodiment, the solid material pieces may be compressed and/or stamped against the covering portion and/or against the at least one covering device and/or while being held and/or limited by the at least one covering device. The degree of compression and/or the jamming effect may thereby be further increased, and the string may accordingly be tightened thereby.

The overall mechanical properties may thus be further improved.

According to a yet further preferred embodiment, the covering portion may allow shifting and/or movements of the solid material pieces. A mechanically stable arrangement of the single solid material pieces may thereby be achieved.

According to a yet further preferred embodiment, the covering portion and/or the at least one covering device may be fixed and/or held by the supporting portion, preferably by the compressed and/or stamped and/or jammed solid material pieces and/or by the string and/or by a compound made of the solid material pieces and the string. A mechanically stable arrangement of the covering portion and/or the at least one covering device may thereby be achieved.

According to a yet further preferred embodiment, the attachment between the string and the at least one covering device is provided via a form fit and/or non-positive connection and/or via an adhesive. Such attachment may provide a high degree of reliability and therewith further improve the long term stability of the construction.

According to a yet further preferred embodiment, the at least one covering device may comprise at least one outer component or a plurality of outer components and at least an attachment element and/or attachment portion for the attachment with the string. The outer component may preferably comprise a visible side facing away from the supporting portion and/or a functional side facing the supporting portion. The attachment element and/or attachment portion may be arranged on the functional side. Accordingly, the attachment element and/or attachment portion may not be visible from the outside or covered by the outer component of the covering device. The outer appearance of the construction may thereby be further improved.

According to a yet further preferred embodiment, the attachment element and/or attachment portion may be configured as a hook and/or eye and/or notch, to which the string is attached and/or hooked. Such an attachment element and/or attachment portion may be provided with only little costs and may provide a secure and long-lasting attachment. Furthermore, an attachment between the string and such attachment element and/or attachment portion may be established with only little effort.

More preferably, the attachment element and/or attachment portion may be configured as and/or comprise a screw, wherein the screw is preferably configured as a concrete screw. Such a screw may be provided at only little cost.

Furthermore, the screw may be screwed into the outer component and/or screwed into the outer component free of any dowel or screw anchor. This may be achieved with only little effort.

The screw may comprises a shaft and a screw head attached to the shaft. The shaft may comprise a protrusion, particularly a radial protrusion, being arranged at a distance from the screw head in a longitudinal direction of the shaft, wherein the shaft and/or the protrusion and/or the screw head may provide a gripping portion for a robot and/or gripping device. This allows facilitated handling operations.

More preferably the screw head and/or the protrusion may be provided with insertion chamfers and/or rounded surfaces and/or wherein insertion chamfers and/or rounded surfaces of the protrusion and the screw head may face each other in the longitudinal direction of the shaft. The insertion chamfers and/or rounded surfaces may be provided for accurate and/or facilitated gripping and alignment of the covering device by a robot or gripping device. The risk of material crushed or high material stresses due to automated gripping procedures may thereby be reduced.

Furthermore, the attachment element and/or attachment portion may comprise a disc for engagement by the string. The disc may comprise a plurality of teeth arranged on the outer circumference of the disc, wherein the teeth may be configured for engagement and/or locking and/or trapping engagement with the string.

The disc may preferably arranged on the shaft of a screw, preferably at distance from the outer component and/or between the outer component and the screw head and/or between the outer component and the protrusion. The string may thus slide into a gap between the outer component and the disc, and when pulled due to a jamming procedure, may be engaged with teeth of the disc with sufficiently high probability.

According to a yet further preferred embodiment, at least two surface components may be attached together via an interconnection, wherein the interconnection preferably provides an attachment element and/or an attachment portion, to which the string attached and/or hooked. The overall effort for generating the construction and/or providing the attachment between the string and the covering devices may be reduced in this way.

It may further prove beneficial when the at least one covering device comprises an identification device, preferably arranged on an attachment element and/or attachment portion. Such identification device may preferably be configured as flat platform and/or for detection by a sensor or visible for a human and/or configured with a position and/or orientation marker and/or a data code or device ID. This allows an easy identification and also the possibility of tracking single covering devices. This may facilitate the generation of the construction, for example, in order to ensure the correct location of single covering devices, and also replacements of single covering devices.

Preferably, the at least one covering device may comprise a shielding portion and/or shielding element arranged on a functional side facing the supporting portion. The shielding portion and/or shielding element may be configured for maintaining a distance between the solid material pieces of the supporting portion and an outer component of the covering device. Accordingly, a free space may be provided between the supporting portion and the outer component of the covering device.

The shielding element and/or shielding portion may be arranged and/or fixed on the attachment element and/or attachment portion of the covering device. Such arrangement or fixation of the element and/or shielding portion may reliably be provided with also only little effort.

According to a yet further preferred embodiment, at least one illuminant, preferably a plurality of illuminants and/or a light chain, may be arranged in a free space between the supporting portion and a visible outer surface of the covering portion, preferably in a free space between the shielding portion or shielding element and the outer component of the covering device. The construction may therewith be further improved in view of an aesthetic appearance and also provide an illumination functionality for the surrounding of the construction, for example for a path or footway along the construction.

Preferably, a plurality of illuminants may be configured to show a light pattern. Such light patterns may be configured for continuous and/or periodic changes, which may further improve the outer appearance or illumination functionality.

Furthermore, a plurality of covering devices may be arranged in a pattern, preferably a predefined and/or optical and/or colour and/or design and/or picture pattern, and/or in a pattern of different stone types, preferably with different aging and/or weathering characteristics, and/or in a pattern with different transparencies and/or translucencies. The possibilities of achieving different design and appearance effects may thereby be further enhanced.

According to a yet further preferred embodiment, two adjacent covering devices may be arranged at a distance from each other and/or a gap may be provided between two adjacent covering devices. Accordingly, a space between two adjacent covering devices and/or between an outer component of a covering device and a shielding component or shielding portion may be visible from the outside, which may be aesthetic, for example, in case of the arrangement of plants or the like within the construction. Also light may shine through such gaps between two adjacent covering devices.

According to a yet further preferred embodiment, the covering portion may comprise a plurality of covering devices and at least some of the covering devices may be arranged in an overhanging configuration and/or overhanging over at least one of the covering devices below. The centre of gravity of an overhanging covering device may be arranged for holding the overhanging covering device in place, preferably also free of any connection to the string. The placement of the overhanging covering device prior to the attachment to the string may thereby be facilitated. Overhanging configurations may allow more complex geometrical overall designs of the construction, and therewith improve the functionality of the construction.

According to a yet further preferred embodiment, a plurality of segments of the supporting portion and/or the covering portion may be provided, the segments being provided independently from each other and/or configured for independent disassembly. It may therefore be possible to refurbish and/or replace selected portions of the constructions, and to maintain different portions. The long term maintenance effort may therewith be reduced.

According to a yet further preferred embodiment, the supporting portion and/or the covering portion may comprise degradable objects, preferably organic material for the development of holes, channels, cavities and/or animal living space. The construction may therewith be well integrated into a natural environment, and also have a positive effect on the surrounding natural environment.

According to a yet further preferred embodiment, the supporting portion and/or the covering portion may enclose and/or comprise at least one functional object, preferably a pipe, pipe segments, a cable, a rigid structure and/or steel bar, which may allow to further improve the functionality and/or stability of the construction. For example, a pipe or cable may allow electrical installations or water installations in or close to the constructions. Steel bars may improve mechanical properties.

Furthermore, the supporting portion and/or the covering portion may enclose a structure connected and/or founded and/or embedded within the respective ground or soil. The string may be connected to a structure connected and/or founded and/or embedded within the respective ground or soil. The mechanical overall properties may further be enhanced. Particularly, the construction may be secured against an unintended tilting relative to the ground or soil.

According to a yet further preferred embodiment, the supporting portion and/or the covering portion may comprise printed structures, preferably 3D-printed structures and/or watertight printed structures and/or printed water storages for plants and/or electrical devices. The functionality of the construction may thereby be advantageously extended, particularly in view of environmental improvements or electrical applications. In general, the supporting portion and/or the covering portion may comprise a watertight portion, preferably for the arrangement or positioning of plants and/or electrical devices.

According to a yet further preferred embodiment, the covering portion may comprise a metal flange, preferably a metal flange mounted to the supporting portion and/or mounted to the supporting portion subsequent to the building of the supporting portion. Such a metal flange may be mounted by at least one hook being inserted into the supporting portion. Such a metal flange may not be attached to the string or also attached to the string. In the region of such metal flange, the supporting portion may be build closer to the outside surface of the entire construction.

According to a yet further preferred embodiment, the covering portion may comprises a top cover portion covering at least the supporting portion from an upper side and/or being positioned on top of a vertically extending side cover portion of the covering portion. The top cover portion may be a 3D printed structure and/or printed as a negative form of the upper surface of the supporting structure and/or the upper surface of the side cover portion. The stability of the construction may thereby be further improved and weathering effects reduced.

According to a yet further preferred embodiment, the top cover portion may be configured to fix and/or receive solid material pieces of the supporting portion and/or covering devices of a vertically extending side cover portion of the covering portion. The top cover portion may have recesses matching to the upper surface of the supporting portion and/or the upper surface of the vertical side cover portion. The top cover portion may be configured as a flat platform, preferably for installation of a roof and/or a light or illumination.

According to a yet further preferred embodiment, the top cover portion may be transparent, translucent and/or from a glass material and/or from frosted glass material. A light source or illumination may be installed on top of the top cover portion in order to illuminate the supporting portion. The outer appearance of the construction may thus be improved, as reflected light may shine out of the supporting portion.

According to a yet further preferred embodiment, a mirror may be installed on top of the supporting portion and/or on top of the top cover portion and/or on top of a light source or illumination, preferably for reflecting light into the supporting portion. Furthermore, the mirror may have overhanging portions and/or may be wider than the total thickness of the supporting portion and covering portion, preferably for reflecting light into the supporting portion along an inner optical path and/or for reflecting light onto the covering portion from the outside, particularly along a light path extending at least section wise outside the covering portion. The overall lighting effect may further be improved in this manner.

According to a yet further preferred embodiment, a light source or illumination source may be attached on top of a post being attached to and/or embedded within the ground or soil and/or wherein wires for the light source or illumination source are connected to the post and/or wherein the light reflecting mirror is attached to the post via at least a screw hole within the post. Such a post may thus not only improve the overall stability of the construction, but at the same time provide attachment functions for specific components of the construction.

According to a yet further preferred embodiment, the supporting portion and/or the covering portion may enclose a fence, preferable a fence comprising a double rod mat attached by clamping elements to a solid pile arranged within the respective soil or ground. Such fences are commonly known and may therefore be enclosed by a supporting portion and/or covering portion with only little effort.

According to a yet further preferred embodiment, vertically extending supporting elements are attached to the double rod mat. Said supporting elements may be configured for supporting solid material pieces of the supporting and transferring their weight load to the double rod mat of the fence. Thereby a specific load distribution within the construction may be achieved.

According to a yet further preferred embodiment, the vertically extending supporting elements are provided by a weatherproof upper portion and a dissolving or degradable lower portion, the dissolving or degradable lower portion being configured for the development of cavities below the supporting elements for improved weight load transferal to the double rod mat. The supporting portion may therewith be reduced from high loads and at least a certain degree of loads may be transferred via different portions to the ground or respective soil.

Furthermore, the double rod mat of the fence may be attached to the top cover portion for transferring a weight load via the top cover portion to the covering portion, in particular to the side portions of the covering portion.

Furthermore, the supporting portion and/or the covering portion may comprise basalt material and/or dunite or olivine material. Such material may remove carbon dioxide from the atmosphere and therefore may have positive ecological effects.

Furthermore, a plurality of solid material pieces of the supporting portion and/or covering devices of the covering portion may be made of basalt rock and/or dunite or olivine material and/or covered by basalt material and/or dunite or olivine material and/or exposed to air and/or wherein the basalt material and/or dunite or olivine material is exposed to weathering and/or configured for weathering and removing carbon dioxide from the atmosphere.

Furthermore, at least some of the solid material pieces and/or covering devices of the covering portion may be covered with powder of basalt rock and/or dunite or olivine material and/or microparticles of basalt rock and/or dunite or olivine material are exposed to the atmosphere for enhanced weathering.

Furthermore, the basalt powder and/or dunite or olivine powder may have a grain size of more than 5 micro meters, more than 10 micro meters, more than 15 micro meters, more than 17.5 micro meters or more than 20 micro meters and/or a grain size of less than 50 micro meters, less than 40 micro meters, less than 30 micro meters, less than 25 micro meters or less than 22.5 micro meters, more preferably 20 micro meters or about 20 micro meters. The size may refer to the mean size of the powder material.

According to a further embodiment, the basalt powder and/or dunite or olivine material may be attached to the solid material pieces and/or the covering devices of the covering portion by a slurry and/or a gel and/or a glue material.

Furthermore, the slurry and/or gel and/or glue material may be permeable for air and/or configured for dissolving, preferably for dissolving in a timeframe between 6 months and 18 months, preferably about 12 months.

According to a further preferred embodiment, a basalt powder or dunite or olivine powder material may be formed to particles of a size of at least 0.5 mm, preferably more than 1 mm or more than 3 mm or more than 5 mm and/or less than 10 mm and these particles may be arranged within the supporting portion and/or the covering portion.

It may furthermore be beneficial, if the supporting portion and/or the covering portion and/or the top cover portion comprises at least one pipe, filling opening and/or tank for filling rock particles, preferably grinded rock particles, and/or a slurry and/or gel and/or glue material with rock material, more preferably for filling rock particles from basalt and/or dunite and/or olivine.

Furthermore, the at least one pipe, filling opening and/or tank may be configured for filling rock particles at an upper portion of the supporting portion and/or the covering portion and/or the top cover portion and/or for distributing the rock particles throughout the supporting portion and/or the covering portion by a stream of liquid, preferably water.

It may also be beneficial, when the supporting portion and/or the covering portion comprises a filter and/or removal opening for filtering and/or removing rock particles, particularly weathered rock particles, in a lower portion of the supporting portion and/or the covering portion, particularly for removing weathered rock particles from drainage water.

According to a further preferred embodiment, at least one sensors may be provided, preferably arranged within the supporting portion and/or the covering portion, said sensor being configured for detecting the weathering status of rock particles.

Accordingly, grinded rock particles comprising basalt and/or dunite or olivine may be inserted on the upper side of the construction into the supporting portion and/or covering portion and then distributed throughout the supporting portion and/or covering portion by a stream of water from above. The particles may fill the spaces of the covering portion without blocking fresh air from passing through the covering portion.

During a certain time period, for example, one year or three years, the particles may start to dissolve, enable weathering of the basalt rock or dunite or olivine or other materials and all residues may be washed through the covering portion. After said time period, said particles may be removed by collecting them in the lower part of the construction by applying a filter which removes these particles from drainage water.

In a preferred solution, dissolution of the particles may be achieved or enhanced through application of charcoal. Charcoal and rock powder may be mixed, for example in a relationship of 1:1, and then compressed under pressure and heat into the final particle shape. Such particles may be arranged within the supporting portion and/or covering portion.

In another preferred solution, dissolution of the particles may be achieved and/or maintained at a desired rate through application of wood pellets. Rock powder may be added to the wood during pellet production. Natural lining inside of the wood may glue the pellets together and prevent fast dissolution. The benefit for application of charcoal or wood inside of the particles may be that both are a natural source of carbon dioxide during their own weathering process. Thus, rock powder may be enclosed by a natural emitter of carbon dioxide.

According to a yet further preferred embodiment, the supporting portion may at least section wise be made from charcoal as solid material pieces and from a metal wire as a string. Furthermore, the supporting portion and/or the covering portion may at least section wise be configured as a chimney. The construction may, accordingly be used for outside heating purposes and/or for decorative purposes in outside events. Furthermore, a covering device may be configured as a door, preferably a fire resistant door and/or being arranged at a distance from charcoal pieces. Such door may be opened to more clearly view fire or glowing charcoal pieces and/or conduct adjustments of singe charcoal pieces.

According to a yet further preferred embodiment, an intermediate layer may be arranged between the supporting portion and the covering portion, preferably an intermediate layer of stones. The intermediate layer may be provided by stones or other sold material pieces with a size equal to or larger than a gap between two adjacent covering devices. Stones or material pieces of the intermediate layer may have a round and/or rounded shape. Stones or material pieces of the intermediate layer may be visible through gaps between two adjacent covering devices. Such intermediate layer may again be arranged for aesthetic or appearance reasons. A viewer from the outside may through this be able to see the covering portion as well as an intermediate layer between the covering portion and the supporting portion. Two different types of material layers may thus be recognized.

A further aspect of the present invention refers to a construction, particularly to a wall and/or pillar structure, comprising solid material pieces and a string for jamming said solid material pieces, wherein at least some of the solid material pieces are made from basalt and/or are at least section wise covered by basalt material and/or dunite and/or olivine material.

A further aspect of the present invention refers to a construction, particularly wall and/or pillar structure, comprising a supporting portion and a covering portion for covering the supporting portion, the supporting portion being provided by solid material pieces and at least one string for jamming at least some of the solid material pieces, wherein the covering portion comprises at least one covering device and wherein the string and the covering device are attached to each other and wherein the supporting portion and/or the covering portion comprise basalt material and/or dunite and/or olivine material.

A further aspect of the present invention refers to a method for servicing a construction according to the above description, the method comprising the steps of frequently and/or periodically applying basalt material and/or dunite and/or olivine material to the solid material pieces and/or to covering devices of a covering portion.

A further aspect of the present invention refers to a covering device, preferably for a construction according to the description above, comprising at least one outer component or a plurality of outer components and at least an attachment element and/or attachment portion for the attachment with a string, the attachment element and/or attachment portion being configured as and/or comprising a screw, preferably a concrete screw, being screwed into the outer component, and wherein the attachment element and/or attachment portion comprises a disc for engagement by a string, wherein the disc is arranged on the shaft of the screw and comprises a plurality of teeth arranged on the outer circumference of the disc, wherein the teeth are configured for engagement and/or locking and/or trapping engagement with a string.

The details and/or advantages described above with regard to the construction likewise apply to the covering device for a construction described above.

A further aspect of the present invention refers to a method for generating a construction, preferably a construction according to the above description. The method may comprise the steps of providing a covering portion with at least one covering device, providing a supporting portion by placing a compound of solid material pieces and at least one string adjacent to the at least one covering device, and attaching the string to the at least one covering device.

As mentioned above with regard to the construction, the supporting portion itself may provide a certain degree of mechanical stability due to the jamming effect, which may be enhanced due to the use of a string. By providing a covering portion with at least one covering device, the outer appearance of the construction may be improved. The string and/or the solid material pieces of the supporting portion may be suitably covered by the covering portion, and therefore less visible or entirely covered. Furthermore, the providing of the covering portion and the attachment of the at least one covering device to the string, allows to further improve the mechanical properties and durability of the construction. The covering portion with the at least one covering device may further enhance the jamming effect within the supporting structure, and particularly prevent single solid material pieces to break out or detach out of the supporting portion. It may therefore be avoided that loose string portions would hang out of the construction. The risk of unintended deteriorations or disassembly processes may be reduced. Due to the attachment of the string with the at least one covering device, the covering device may be suitably held in place and also provide holding support for at least some of the solid material pieces of the supporting structure.

According to a preferred embodiment, at least two covering portions and/or at least two covering devices are arranged opposite to each other. The supporting portion may be arranged between at least two opposite covering portions and/or between at least two covering devices.

According to a preferred embodiment, the at least one covering portion may provide a cast for the supporting portion and/or for the compound of solid material pieces and at least one string.

Preferably, the solid material pieces may be jammed by the string and/or by stamping and/or compacting. The overall stability of the supporting portion may thereby be further enhanced.

According to a yet preferred embodiment of the method, the string may at least section wise laid within and/or throughout the supporting portion and/or between the solid material pieces and/or loosely laid and/or at least section wise tightened, preferably for increasing a jamming effect.

According to a yet preferred embodiment of the method, the string is laid in a pattern alternatingly running between a central area of the supporting portion and different covering devices. The jamming effect may thus be further enhanced, particularly ensuring a proper cast or holding functionality provided by the covering portion.

The details and/or advantages described above with regard to the construction and the covering device likewise apply to the method for generating a construction described above.

Yet further aspects and embodiments of the present invention, in particular with regard to a construction system and construction machine, are described hereinafter in a second supplement description. All features or feature combinations of the aspects and embodiments described in the second supplement description below may be combined with the aspects and/or embodiments described above or specified in the claims of the present invention. It is noted that a robot device described below may be used as a synonym for a construction machine within the meaning of the present invention.

A construction system according to an aspect may particularly be suitable for operation by an end-user, such as, for example, an end-consumer and/or an owner or user of a residential estate, property and/or garden land.

A construction system according to a further aspect may comprise a robot device configured for constructing a wall and/or pillar structure, and at least one marking device for defining the course, form and/or position of a wall and/or pillar structure.

The marking device may be detectable by the robot device, and the robot device may be configured to construct a wall and/or pillar structure at and/or along the marking device.

The use of a marking device in combination with a robot device, which may detect the marking device, may ensure a higher flexibility as well as a lower complexity for the operation of the construction system. In particular, an end-user may lay out the marking device along an intended course and/or position of a wall and/or pillar structure to be built. Subsequently, the robot device may be put into operation for constructing a wall and/or pillar structure along and/or at the marking device with no or only little input by the end-user. The presence of highly skilled operating personnel is therefore no longer required at the construction site.

Accordingly, the robot device may be pre-programmed to detect and/or follow the marking device and/or to conduct construction operations at and/or along the marking device. The pre-programming of the robot device may, in particularly, be such that an end-user with no or only little programming knowledge may initiate construction operations to be conducted by the robot device.

According to a preferred embodiment of the present invention, the marking device may be configured as and/or comprises an elongated and/or flexible device and/or is configured to be laid out by an end-user along an intended course and/or position of a wall and/or pillar structure. The marking device may be provided in a rolled, wound and/or folded fashion and may therefore allow an easy handling by an end-user, particularly before and/or during a laying out procedure.

According to a further preferred embodiment, the marking device may be configured as and/or comprises a wire, cord, tape and/or belt being detectable by a sensor of said robot device. Particularly, the marking device may be configured as and/or comprise a sensor wire being detectable by a sensor of said robot device. Such a marking device may be provided at only little cost and may be easily laid out and/or brought into position for defining the course and/or position of a wall and/or pillar structure.

Preferably, the marking device may comprise a measure scale detectable by said robot device and/or by operating personnel. A measure scale may improve the operating precision before as well as during construction of a wall and/or pillar structure, and also facilitate possible planning activities, such as measuring operations by an end-user.

According to a further preferred embodiment, the marking device may comprise at least a start marker for marking the start of a wall structure and/or the position of a pillar structure to be constructed and/or an end marker for marking the end of a wall structure and/or the position of a pillar structure to be constructed. The start and/or the end of a wall structure and/or the position of a pillar structure may thus be easily detected by the robot device. Therefore the construction of a wall and/or pillar structure with high precision may be ensured.

According to a further preferred embodiment, the marking device may comprise a feature marker, preferably for marking the position of features and/or extensions and/or interruptions or gaps of the wall and/or pillar structure to be constructed. Such an interruption or gap may form an entry gate within the wall and/or pillar structure. The versatility of the construction system and also of the respective construction to be built may therewith be further improved.

Preferably, the marking device may comprise a storage marker for marking the position of a material storage for construction material. The organizational degree for the operation of the construction system may thereby be improved and automation further facilitated.

It is also possible that the marking device comprises a supply marker for marking the position of a power supply and/or a water supply connection. The functionality of the wall and/or pillar structure may thereby be improved, while at the same time ensuring a high level of automation for the construction process.

According to a further preferred embodiment, the construction system further comprises a platform providing a driving and/or rolling surface for the robot device. The robot device, particularly the wheels of the robot device, may be protected from a wet and/or muddy underground. The risk of unintended stops of the robot device during movement or travelling may thereby be reduced.

Preferably, the platform consists of a plurality of platform elements, which allows achieving comparatively large platform surfaces. Furthermore, the platform may be connected with the marking device. The position of the platform relative to the marking device may thereby be maintained with high precision and reliability.

The platform may furthermore comprise a storage section for storing construction material. Preferably, the platform comprises at least one elevation ramp and/or elevation element for providing a driving and/or rolling surface on an elevated level, particularly elevated relative to at least one further platform element. In case a wall and/or pillar structure will be higher than the arm range of the robot device, the robot device may be able to move or drive up the elevation ramp, and follow the line of the marking device on an elevated path. It is then possible to continue with the construction on an elevated level, and therewith construct wall and/or pillar structures with comparatively large height.

According to a further preferred embodiment, the construction system further comprises a delivery marking device for marking a construction material and/or construction equipment delivery zone. Such delivery marking device is detectable by delivery trucks and/or delivery equipment. It is also possible that such delivery marking device is detectable by delivery personnel, with or without using delivery equipment. The delivery marking device may be attached or connected to the marking device for defining the course, form and/or position of a wall and/or pillar structure. The delivery marking device may also be arranged and/or configured to be arranged at a distance from the marking device for defining the course, form and/or position of a wall and/or pillar structure. The delivery of required construction materials and equipment may therewith be further facilitated or automated.

According to a further preferred embodiment, the robot device is configured for constructing a wall and/or pillar structure from solid material pieces and a string for jamming said solid material pieces. More generally, the robot device may be configured for constructing a construction from solid material pieces and a string for jamming said solid material pieces. A construction according to the present invention may particularly be a wall and/or pillar structure, but is not limited thereto. A construction according to the present invention may generally refer to different types, forms and sizes of architectural structures. Particularly, a construction according to the present invention may be an enclosure for the yard of a property, such as a front yard and/or back yard.

According to a further preferred embodiment, the robot device may be configured for constructing a wall and/or pillar structure with a supporting portion and a covering portion for covering the supporting portion, the supporting portion being provided by solid material pieces and at least one string for jamming at least some of the solid material pieces and the covering portion comprising at least one covering device, wherein the robot device is configured for attaching the string to the at least one covering device.

The supporting portion itself may already provide a certain degree of mechanical stability due to the jamming effect, which may particularly be enhanced due to the use of a string. Now, by providing a covering portion with at least one covering device, the outer appearance of the construction may be improved. The string and/or the solid material pieces of the supporting portion may be suitably covered by the covering portion, and therefore less visible or entirely covered.

At the same time, the providing of the covering portion and the attachment of the at least one covering device to the string, allows to further improve the mechanical properties and durability of the construction. The covering portion with the at least one covering device may further enhance the jamming effect within the supporting structure, and particularly prevent single solid material pieces to break out or detach out of the supporting portion. Accordingly, it may also be avoided that loose string portions would hang out of the construction. This reduces the risk of unintended deteriorations or disassembly processes. Due to the attachment of the string with the at least one covering device, the covering device may be suitably held in place and also provide holding support for at least some of the solid material pieces of the supporting structure.

According to the present invention, the term “string” is not limited to textile, synthetic or metallic strings, but may refer to every kind of elongated flexible attachment means. For example, a “string” within the meaning of the present invention may likewise refer to a flexible cable, chain, belt, and/or strap, synthetic fibre or carbon fibre strings, or the like.

According to a preferred embodiment of the present invention, the construction system may be configured to generate a dry construction, particularly a dry wall system or dry pillar system. The assembly or generation process may therewith be facilitated as no water adding and drying steps are required. The construction system according to the present invention may thus be configured to generate such dry construction, particularly such dry wall system or dry pillar system.

According to a preferred embodiment, the construction system may be configured for disassembly, at least for part-disassembling, by pulling out the string of a supporting portion. In particular, the construction system may be configured for disassembly by reversing an assembly process. The quality and/or usability of the single construction components may therefore be maintained also after disassembly. Furthermore, disassembly may be favourable if cleaning the construction does not compensate aging effects, e.g. cleaning equipment does not reach into gaps or pores of solid material pieces or covering devices. Disassembly can then enable individual cleaning of each component until the aging effects are suitably removed.

Furthermore, the construction system may be configured to generate a supporting portion and/or covering portion at least section wise arranged and/or assembled within soil ground and/or below the ground surface and/or within a hole in soil ground, preferably below the frost line. Therewith, the construction may replace a basement or groundwork of an architectural structure, particularly in case of intense ground movements.

According to a further preferred embodiment, the construction system may be configured to generate a covering portion arranged around a supporting portion and/or on a plurality of sides of the supporting portion. The covering portion may provide a cast for the supporting portion, particularly a cast for a compound of the solid material pieces and the string of the supporting portion. The mechanical properties and durability of the construction as well as the outer appearance may thereby be further improved. By providing a cast, the building of the supporting structure may furthermore be facilitated.

According to a further preferred embodiment, the construction system may be configured to generate a construction with at least one covering device made from a different material and/or having a different optical appearance than at least some of the solid material pieces of the supporting structure. The covering device may accordingly be chosen in view of appearance criteria, and the construction system may be configured and/or pre-programmed for selecting according covering devices.

According to a further preferred embodiment, the construction system may be configured to jam and/or stamped and/or compressed solid material pieces, preferably for increasing a jamming effect. The stability of a supporting portion may thereby be further improved.

According to a further preferred embodiment, the construction system may be configured to at least section wise lay a string within and/or throughout a supporting portion and/or between solid material pieces and/or loosely lay and/or at least section wise tighten a string, preferably for increasing a jamming effect. Thereby, the mechanical properties and durability of a supporting portion may further be enhanced.

According to a further preferred embodiment, the construction system may be configured to arrange a string in a pattern alternatingly running between a central area of a supporting portion and different covering devices. The contribution of the string to the jamming effect within the supporting portion may thereby be further improved.

According to a further preferred embodiment, the construction system may be configured to generate a construction with a covering portion comprising a plurality of covering devices, preferably arranged adjacent to each other and/or along and/or adjacent to the supporting portion. A larger surface may thereby be covered and/or a larger cast for the supporting portion be provided. The string may be attached to a plurality of covering devices, preferably to a plurality of covering devices on different sides of the supporting portion. The overall stability of the construction may be further improved in this manner.

According to a yet further preferred embodiment, the at least one covering device may be made of and/or comprises a stone and/or glass and/or metal material. Such materials may provide an aesthetic appearance, while at the same time allowing a sufficient holding functionality for the supporting portion, particularly a stable cast for the supporting portion.

According to a yet further preferred embodiment, the at least one covering device may comprise a visible side facing away from the supporting portion and/or a functional side facing the supporting portion, wherein the construction system may be configured to attach a string to the covering device at the functional side. The functional side may therefore be specifically designed for the attachment of the string, and the visible side be designed or provided for an improved or high quality appearance.

According to a yet further preferred embodiment, the construction system may be configured to compress and/or stamp the solid material pieces against the covering portion and/or against the at least one covering device and/or while being held and/or limited by the at least one covering device. The degree of compression and/or the jamming effect may thereby be further increased, and the string may accordingly be tightened thereby. The overall mechanical properties may thus be further improved.

According to a yet further preferred embodiment, the construction system may be configured to provide an attachment between the string and the at least one covering device via a form fit and/or non-positive connection and/or via an adhesive. Such attachment may provide a high degree of reliability and therewith further improve the long term stability of the construction.

According to a yet further preferred embodiment, the construction system may be configured to generate a construction, in which at least one covering device comprises at least one outer component or a plurality of outer components and at least an attachment element and/or attachment portion for the attachment with a string. The outer component may preferably comprise a visible side facing away from the supporting portion and/or a functional side facing the supporting portion. The attachment element and/or attachment portion may be arranged on the functional side. Accordingly, the attachment element and/or attachment portion may not be visible from the outside or covered by the outer component of the covering device. The outer appearance of the construction may thereby be further improved.

The attachment element and/or attachment portion may be configured as a hook and/or eye and/or notch, to which the string is attached and/or hooked. Such an attachment element and/or attachment portion may be provided with only little costs and may provide a secure and long-lasting attachment. Furthermore, an attachment between the string and such attachment element and/or attachment portion may be established with only little effort by a construction system according to a preferred embodiment of the present invention.

According to a yet further preferred embodiment, the construction system may be configured to identify at least one covering device via an identification device, preferably arranged on an attachment element and/or attachment portion. Such identification device may preferably be configured as flat platform and/or for detection by a sensor or visible for a human and/or configured with a position and/or orientation marker and/or a data code or device ID. This allows an easy identification and also the possibility of tracking single covering devices. This may facilitate the generation of the construction, for example, in order to ensure the correct location of single covering devices, and also replacements of single covering devices.

According to a yet further preferred embodiment, the construction system may be configured to arrange at least one illuminant, preferably a plurality of illuminants and/or a light chain, in a free space between a supporting portion and a visible outer surface of a covering portion. The construction may therewith be further improved in view of an aesthetic appearance and also provide an illumination functionality for the surrounding of the construction, for example for a path or footway along the construction.

Preferably, a plurality of illuminants may be configured to show a light pattern. Such light patterns may be configured for continuous and/or periodic changes, which may further improve the outer appearance or illumination functionality.

According to a yet further preferred embodiment, the construction system may be configured to arrange a plurality of covering devices in a pattern, preferably a predefined and/or optical and/or colour and/or design and/or picture pattern, and/or in a pattern of different stone types, preferably with different aging and/or weathering characteristics, and/or in a pattern with different transparencies and/or translucencies. The possibilities of achieving different design and appearance effects may thereby be further enhanced.

According to a yet further preferred embodiment, the construction system may be configured to arrange two adjacent covering devices at a distance from each other and/or a gap may be provided between two adjacent covering devices. Accordingly, a space between two adjacent covering devices and/or between an outer component of a covering device and a shielding component or shielding portion may be visible from the outside, which may be aesthetic, for example, in case of the arrangement of plants or the like within the construction. Also light may shine through such gaps between two adjacent covering devices.

According to a yet further preferred embodiment, the construction system may be configured to provide a covering portion with a plurality of covering devices and at least some of the covering devices may be arranged in an overhanging configuration and/or overhanging over at least one of the covering devices below. The centre of gravity of an overhanging covering device may be arranged for holding the overhanging covering device in place, preferably also free of any connection to the string. The placement of the overhanging covering device prior to the attachment to the string may thereby be facilitated. Overhanging configurations may allow more complex geometrical overall designs of the construction, and therewith improve the functionality of the construction.

According to a yet further preferred embodiment, the construction system may be configured to enclose a structure connected and/or founded and/or embedded within the respective ground or soil with a supporting portion and/or covering portion. The string may be connected to a structure connected and/or founded and/or embedded within the respective ground or soil. The mechanical overall properties may further be enhanced. Particularly, the construction may be secured against an unintended tilting relative to the ground or soil.

According to a yet further preferred embodiment, the construction system may be configured to provide a top cover portion covering at least the supporting portion from an upper side and/or being positioned on top of a vertically extending side cover portion of the covering portion. The top cover portion may be a 3D printed structure and/or printed as a negative form of the upper surface of the supporting structure and/or the upper surface of the side cover portion. The stability of the construction may thereby be further improved and weathering effects reduced.

According to a yet further preferred embodiment, the top cover portion may be configured to fix and/or receive solid material pieces of the supporting portion and/or covering devices of a vertically extending side cover portion of the covering portion. The top cover portion may have recesses matching to the upper surface of the supporting portion and/or the upper surface of the vertical side cover portion. The top cover portion may be configured as a flat platform, preferably for installation of a roof and/or a light or illumination.

According to a yet further preferred embodiment, the construction system may be configured to provide an intermediate layer between a supporting portion and a covering portion, preferably an intermediate layer of stones. The intermediate layer may be provided by stones or other sold material pieces with a size equal to or larger than a gap between two adjacent covering devices. Stones or material pieces of the intermediate layer may have a round and/or rounded shape. Stones or material pieces of the intermediate layer may be visible through gaps between two adjacent covering devices. Such intermediate layer may again be arranged for aesthetic or appearance reasons. A viewer from the outside may through this be able to see the covering portion as well as an intermediate layer between the covering portion and the supporting portion. Two different types of material layers may thus be recognized.

According to a preferred embodiment of the present invention, the robot device may be configured for operation and/or initialization by an end-user without programming knowledge and/or by an unskilled worker. Furthermore, the robot device may be configured for autonomous operation and/or configured as mobile autonomous robot device. The operation flexibility and versatility may therewith be further improved.

According to a further preferred embodiment of the present invention, the robot device may be configured for following the marker device and for reading markers and/or for drawing the contour of the intended wall and/or pillar structure into a map and/or for creating a 3D model of the environment. The degree of automation and planning functions may therewith be further improved.

According to a further preferred embodiment, the 3D model and/or pictures of the ground for the wall and/or pillar structure to be constructed may be submitted to a provider and/or cloud for data analysis, preferably for automated data analysis and/or manual data analysis by an expert. The risk of failure during operation of the construction system for constructing a wall and/or pillar structure may therewith be further reduced.

According to a further preferred embodiment, the construction system may further comprise an ordering device for ordering construction material based on the data collected by the robot device and/or further analysed. The user friendliness may therewith be further improved.

According to a yet further preferred embodiment, the robot device may be configured to detect and/or identify delivered construction material and/or initiate opening sequences for material packages. The requirements for handling processes to be conducted by an end-user may thus be further reduced.

According to a yet further preferred embodiment, the robot device may comprise a robot, preferably configured with a serial kinematic arrangement, and/or a mobile platform for moving a robot. The robot may have an arm with a serial kinematic arrangement. The robot may be driven or rolled by the mobile platform along a path or line, in particular along the marking device for collecting data and/or for constructing a wall and/or pillar structure. The mobile platform enhances the working range of the robot, and therefore allows the generation of comparatively large structures.

According to a yet further preferred embodiment, the robot device and/or the robot may have a maximum weight of less than 200 kg, preferably less than 150 kg or less than 100 kg. Delivery of the robot device and/or the robot to the construction site may thus be conducted with only little effort. In particular, the robot device and/or the robot may easily be lifted out of a trunk of a car or a loading area of a truck, particularly by one or two persons, with or without lifting equipment, and safely positioned on or close to the construction site.

Preferably, the robot may be attachable to the mobile platform, particularly by an end-user and/or by an unskilled worker and/or in a tool-free manner. The robot and the mobile platform have a modular design. The operation of the robot device by an end-user may thus be further facilitated.

According to a yet further preferred embodiment, the robot device, particularly the robot and/or the mobile platform, may comprise a sensor device for detecting the marking device and/or a detection device for detecting packaged material and/or material packages with or without detection markers. The degree of automation and/or autonomous operability may therewith be further improved.

According to a yet further preferred embodiment, the robot device and/or the robot may be provided with an end-effector configured as a gripper and/or with a drive tool for driving a string, preferably for unwinding a string material and/or for driving a string material out of a string package. Furthermore, such gripper may be configured for gripping solid material pieces, preferably stones, and/or said drive tool for driving a string. The end-effector may thus be used for the gripping, lifting and/or repositioning of solid material pieces. At the same time, the end-effector may be used for gripping a drive tool, which itself has a different basic functionality than the gripper itself. By providing such gripper and also a corresponding drive tool which may be operated while being gripped by the gripper, the necessity of changing the end-effector during operation may be reduced or completely avoided.

According to a further preferred embodiment, the robot device and/or the robot may be provided with a drive tool for driving and/or equipped with a basalt fibre and/or basalt rope, preferably with basalt fibre and/or basalt rope resistive to temperatures above 500° C. or above 600° C. or above 700° C. and/or with recyclable basalt fibre and/or basalt rope. Accordingly, a compound of rock gravel and string may be a compound of basalt material only, particularly without other materials and therefore being very easy for recycling and being resistive to high temperatures during a fire. Also such compound may be able to endure for many years without corrosion, weathering of fibre or other signs of malfunction.

Furthermore, the robot device and/or the robot may be provided with a drive tool for driving and/or equipped with a basalt fibre and/or basalt rope, preferably with bas-alt fibre and/or basalt rope resistive to temperatures above 500° C. or above 600° C. or above 700° C. and/or with recyclable basalt fibre and/or basalt rope. Any construction provided by such construction system may be particularly durable. It may furthermore prove beneficial in case the robot device and/or the robot is provided with a drive tool for driving and/or equipped with a string and/or basalt fibre and/or basalt rope having between 200 tex to 1000 tex, more preferably between 300 tex to 900 tex or 300 tex to 600 tex or 600 tex to 900 tex or 800 tex to 950 tex or 500 tex to 700 tex or 250 tex to 350 tex, more preferably of about 300 tex, 600 tex or 900 tex. Such string and/or basalt fibre and/or basalt rope may be sufficiently light in weight for good handling purposes.

According to a yet further preferred embodiment, the robot device and/or the robot may be provided with a drive tool for driving and/or equipped with a string and/or basalt fibre and/or basalt rope having configured to withstand a pulling force of 50 N to 500 N, more preferably of 100 N to 300 N, more preferably of 100 N to 200 N or 200 N to 300 N, or about 100 N, 200 N or 300 N. Therewith, sufficient stability of a construction to be built with the construction system may be ensured.

According to a yet further preferred embodiment, the drive tool may be detachable from the robot and/or the gripper together with the respective string and/or string package and/or without any handling by an end-user or operator. Furthermore, the drive tool may be attachable to the robot and/or to the gripper together with the respective string and/or without handling by an end-user or operator.

According to a yet further preferred embodiment, the robot device and/or the robot may be provided with an end-effector configured as a gripper, said gripper being equipped with a set of gripper pads and the geometry of said gripper pads being designed to grip at the flange portion of a covering device by closing gripper fingers, and/or wherein said gripper may be configured as hole gripper. Thereby, pick-and-place operations of covering devices may be conducted with a high degree of operational safety. Also different kind of covering devices may be gripped and replaced if required.

Accordingly, the robot and/or robot device may be connected and/or disconnected from the yet unfinished construction, in order to conduct different tasks without or with only little retooling effort. In other words, the drive tool may be detached from the gripper to remain on top of the yet unfinished wall and/or pillar structure. The robot device may then carry out side tasks and/or stones handling task, particularly moving stones from a bin to the wall and/or pillar structure without any tool change at the end-effector. The robot device is able to reattach the drive tool to the end-effector whenever required.

According to a yet further preferred embodiment, the drive tool may be configured for driving and/or pulling a string out of a string device, particularly out of a string package or string bag, and/or configured for unwinding a string with a defined speed. The automated deployment of a string within a construction, particularly within a wall and/or pillar structure, may therewith be facilitated.

The drive tool may furthermore be configured for detecting an increase of drive forces. A significant increase of drive forces may be indicated that the respective string has reached an end or an end of a string has reached an obstacle, such as a package opening, and therefore a string or string device with a string to be driven by the drive tool needs to be exchanged.

According to a yet further preferred embodiment, the drive tool may comprise a guiding portion for a string, at least one driving wheel for engaging a string to be driven, and at least a coupling portion adapted to the inner shape of a robot gripper and configured to establish a fixed coupling with a robot gripper by closing the fingers of said robot gripper. Such drive tool is particularly suitable for a controlled feeding or driving of a string into a construction. At the same the coupling portion may allow to easily operate such drive tool while being in a position gripped between the fingers of a robot gripper. It is therefore not required to install such drive tool as an end-effector in a conventional manner, but the drive tool itself may be held by an end-effector, and operated in this position.

According to a yet further preferred embodiment, the construction system may further comprise a string device comprising a string, a package for said string and two connector end pieces attached to the ends of said string, wherein the string is guided through a guide through opening of said package and one of the connector end pieces is arranged within the package and/or one of the connector end pieces is arranged outside the package. Such a string device allows an easy integration of a string into a robot device for driving said string. Such a string device may particularly be attached to a driving tool for automated driving of a string. Further to this, such string device may be replaced with only little effort, and with only little risk of the string being entangled.

According to a yet further preferred embodiment, the connector end pieces may be configured as magnetic end pieces and/or are configured to establish a holding connection with the connector end piece of another string, preferably a holding connection with a portion of the package in between two respective connector end pieces. It may therefore not be required to move the respective string entirely out of a package in order to establish a holding connection with another string, and therefore the handling effort may be reduced.

According to a yet further preferred embodiment, the string device may further comprise a guiding device for said string, preferably a guide through pipe, being attached to the package and/or extending from the guide through opening of the package and/or extending from an outer side of the package. The guiding device may ensure a reliable driving or feeding motion of the string. Furthermore, such guiding device may be attached to the package via an attachment flange. The stability of connection between the guiding device and the package may thus be improved.

According to a yet further preferred embodiment, the guiding device may comprise an exposing portion for exposing a string guided through said guiding device, wherein the exposing portion is preferably provided by an interruption of and/or an opening in said guiding device. Said string may be engaged by a drive tool thorough said exposing portion, particularly for driving and/or pulling said string out of said package. Engagement of the string by a drive tool may be facilitated and a reliable driving functionality ensured.

According to a yet further preferred embodiment, the robot device may be configured for collecting, storing and/or transmitting block chain related data about solid material pieces embedded within a wall and/or pillar structure. The robot device may thus be integrated into a block chain system. The versatility of the construction system is thereby further improved.

Preferably, the robot motion data may provide a proof of work. The ID of a solid material piece, such as a stone, may be assigned by the respective manufacturer and may be unique. Any sequence associated with a material piece ID may be a proof of existence and/or position and/or disassembly of a solid material piece.

In a preferred solution, an end-user may be interested to prove to a trust less block chain system that he is in possession of a stone wall. This may be a proof of physical ownership or possession to a virtual block chain. Block chains may rely on “proof of work”, also known as mining. This proof of work could be replaced by another proof of work to any physical reality which, in contrast to most data, may be impossible to be multiplied or copied or faked. In other words, the proof of physical possession may be a suitable replacement for “proof of work”, if the object would reveal a code during its production and only reveal it again after destruction or disassembly and/or in case the production or assembly sequence would not allow an operator or end-user to take notice of any block-chain related data to be collected, stored and/or transmitted by the robot device. Preferably, the respective material piece with its ID would be arranged in an immovable manner, at least temporarily immovable. The proof of physical possession may in this way be possible without the need to trust a human person.

In a preferred solution, the robot device may connect the covering devices with a string to hooks below a platform with a stone-id code. The robot device may choose a random sequence of stones and may be configured to store the sequence of stone-ID codes such that when the segment is finished, the robot uses the stone-ID sequence as an encryption key and encrypts data and then deletes the stone-ID code such that the unencrypted sequence is only contained in the wall segment. Thereby, so called “proof of work” or “proof of stake” of may be replaced by a physical proof of possession of a wall segment.

In a preferred embodiment, the robot device electronics and drive for each axis may be located in that respective axis and the electronics comprising an encryption protocol which has an own secret ID and it may also be configured to analyse the axis motion pattern and to create a hash key and submit the hash key to a blockchain.

Submitted data may provide both evidence that a particular robot device has been building a wall and/or pillar structure and the submitted proof of building a wall and/or pillar structure may be the result from that particular robot device building this wall and/or pillar structure and not somebody only pretending to do so.

In a preferred solution, the proof of possessing the wall and/or pillar structure may need to be renewed after a certain period, for example after a period of e.g. 5 years, and the blockchain system may chose arbitrarily one segment number of the wall to be disassembled by a robot device according to the present invention. It may read out backwards the sequence of stone-ID recovering at least 95% of the ID in the correct sequence. As a result the robot device may be able to proof that the whole wall was 5 years in possession; and the stones or solid material pieces may be applied to build a new wall and/or pillar segment.

According to a yet further preferred embodiment, the construction system may further comprise an anti-theft protection device for the robot device, said anti-theft protection device preferably being provided by a security wire, and/or wherein the robot is configured for automated attachment to and/or detachment from an antitheft protection device. The risk of the robot device to be stolen may thereby be reduced.

Such theft-protection may particularly be suitable for a robot device being mobile, lightweight and small. Due to the high cost, such robot device may likely become a target to theft. Especially, when operated near or on a public ground, theft protection may become important.

Preferably, the robot device may attach itself to a security wire, which is hard to break. Such security wire may either be part of the marking device, such as sensor wire, or it maintains at a fixed distance to it. Furthermore, when the robot device detects the marking device, it would also be able to detect the security wire and attach the mobile platform to it.

According to a preferred solution, the robot may be configured to attach itself to a security wire. Thereby, it can pass a section of the security wire, where the security wire itself is attached to a ground hook or the like. For this purpose, the robot device may first attach the end of the robot arm behind a ground hook, then detach the mobile platform from the security wire, traverse the ground hook and reattach the mobile platform. In a further preferred solution, the robot device may be configured to attach the robot and/or the robot arm directly to a ground hook.

In a further preferred solution, the security wire may be replaced by a pipe. Such pipe may be very hard to destroy. In case of a human path leading through the robot path, the security wire may not be laid across the human path to prevent human accidents. Instead, the robot device may be configured to attach the robot or robot arm to a door or gate defined by a wall and/or pillar structure, which may be finished or unfinished.

In a further preferred solution, the wall and/or pillar structure may not require a door or gate. The robot device may in such case be configured to detect intrusion. A gate may be replaced by a symbolic rope. Inside such rope, a security wire may be located. Thus, the robot device would attach to that rope, move the rope to the other side of the respective wall or pillar and attach itself to that side of the wall or pillar. The symbolic rope may then be closed and the robot would be able to traverse without detaching itself. In a further preferred solution, the robot device may be configured to open a rope for guests or habitants.

The present invention has been described as construction system above. However, the present invention also refers to a service system or automation system in general. Accordingly, the construction system referred to herein may likewise be a service system in general, particularly for providing different types of services by said robot device. Such service system may influence physical, ecological and social effects and interactions through the boundaries of a property, site or land plot. The robot device may be configured to construct, secure, treat, clean, extend, modifies, disassembles and/or reprocess an enclosure, such as a wall and/or pillar structure, made of solid material pieces, preferably stones, as well as a string, such as a cord or thread. Cohesion of stone and string compound may essentially be achieved by the so called “jamming effect”, as discussed above. The surface of the compound may be provided by a refined layer of high quality stones, which may be connected to the string during the construction process.

The construction system or service system according to the present invention may enables to autonomously purchase supply parts and material and interaction with parcel service and suppliers, to commission, unpack, store, sort, scan and/or measure incoming goods. The owner or end-user may be provided with aggregated process information on the progress, whereas more detailed process decisions may be made autonomously by the construction system or service system or by a service provider, who may permanently be connected to the robot device.

According to a yet further preferred embodiment, the robot device may be configured to perform at least one secondary task, preferably observation of animal intrusion using an integrated camera system, preventing animal intrusion by providing light inside the wall and/or pillar structure and/or by providing motion of the robot device and/or sound. It is particularly possible to prepare and/or present video and/or picture material to an end-user, who would may then decide if an intruder is a welcome part of a garden or not. The end-user would also be able to define an animal as domestic part of the household and configure the robot device accordingly. Light inside a wall and/or pillar structure, robot motion and/or sound may be applied to train animals not the pass a threshold, such as a wall and/or pillar structure.

According to a yet further preferred embodiment, the robot device may be configured to perform a secondary task in the form of humidity control for a garden, particularly by generating a humidity map of the soil, measuring nutrition levels of the soil, identifying plants based on their leaves, measuring light intensity and/or continuously matching light intensity, humidity, nutrition levels, size of plants and/or plant types.

Preferably, a sensor attached to the robot device may be applied to create a humidity map of the soil along a pathway. With another sensor, it would be possible to measure light intensity. With a third sensor, it would be possible to measure nutrition levels of soil. Applying computational analytics it may be possible to identify plants based on their leaves. A map may continuously match light intensity, humidity, nutrition levels and size of plants to the plant type. From such map, users would be enabled to derive measures to optimize garden quality. The robot device may be configured to create such map and/or contribute to the generation of such map. One goal of such map may be to control the flora on a wall and/or pillar structure, both intended and unintended growth. Unintended growth may be especially moss and lichens. In case of unintended growth, preventive measures may be suggested by the construction system to the end-user instead of reactive solutions.

A further aspect of the present invention refers to a drive tool, preferably for a construction system or service system described above. Accordingly, a construction system or service system described above may be equipped with a drive tool described hereinafter including all different embodiments of such drive tool.

A drive tool according to the present invention may comprise a guiding portion for a string, at least one driving wheel for engaging a string to be driven, and at least a coupling portion adapted to the inner shape of a robot gripper and configured to establish a fixed coupling with a robot gripper by closing the fingers of said robot gripper. The drive tool may thus be operated while being gripped by a gripper, and the necessity of changing the end-effector during operation may be reduced or completely avoided.

According to a preferred embodiment, the drive tool may further comprise at least one wireless functionality and/or wherein the at least one driving wheel is electrically powered, preferably by battery, and/or configured for wireless operation and/or configured for receiving operational commands via a wireless connection to a robot device and/or robot. The necessity of a physical data or power connection between the drive tool and the robot may thus be avoided. Operational reliability may thereby be improved.

According to a preferred embodiment, the drive tool may comprise two driving wheels for engaging a string to be driven, said driving wheels being preferably arranged opposite to each other for enclosing a string to be driven, and/or wherein at least of the driving wheels is provided with a tensioning device, preferably a spring, for providing a tensioning force of said driving wheel against said string. This allows a secure and reliable drive process for a string, and may thus facilitate the generation of a so called jamming structure with automation equipment.

According to a further preferred embodiment, the drive tool may further comprise at least two body parts, preferably two body halves, configured to be moved relative to each other, particularly for opening and/or closing movements. The body parts may be configured to be moved relative to each other by relative movement of gripper fingers of a robot gripper. Furthermore, the body parts may be configured to be locked in an opened and/or closed position and/or wherein at least one tensioning element is provided for providing pretension to said body parts. The pretension may be oriented in an opening and/or closing direction of the body parts. Different operational positions of the drive tool may thereby be achieved with only little effort.

According to a further preferred embodiment, the guiding portion for a string is defined between the body parts in a closed position and/or wherein a driving wheel is provided on each body part. Initial engagement of a string by a driving wheel of the drive tool may thereby be facilitated.

A further aspect of the present invention refers to a string device, preferably for a construction system or service system and/or for a drive tool described above. Accordingly, a construction system or service system described or also a drive tool described above may be equipped with a string device described hereinafter including all different embodiments of such string device.

A string device according to the present invention may comprise a string, a package for said string and two connector end pieces attached to the ends of said string, wherein the string is guided through a guide through opening of said package and wherein one of the connector end pieces is arranged within the package and/or one of the connector end pieces is arranged outside the package. Such a string device allows an easy integration of a string into a robot device for driving and deploying said string. Such a string device may particularly be attached to a driving tool for automated driving of a string. Further to this, such string device may be replaced with only little effort, and with only little risk of the string being entangled.

According to a further preferred embodiment of the string device, the connector end pieces are configured as magnetic end pieces and/or are configured to establish a holding connection with the connector end piece of another string, preferably a holding connection with a portion of the package in between two respective connector end pieces. It may therefore not be required to move the respective string entirely out of a package in order to establish a holding connection with another string, and therefore the handling effort may be reduced.

According to a further preferred embodiment, the string device may further comprise a guiding device for said string, preferably a guide through pipe, being attached to the package and/or extending from the guide through opening of the package and/or extending from an outer side of the package and/or wherein said guiding device is attached to the package via an attachment flange. The stability of connection between the guiding device and the package may thereby be improved.

According to a further preferred embodiment of the string device, the guiding device may comprise an exposing portion for exposing a string guided through said guiding device, wherein the exposing portion is preferably provided by an interruption of and/or an opening in said guiding device, and/or wherein said string may be engaged by a drive tool thorough said exposing portion, particularly for driving and/or pulling said string out of said package. Engagement of the string by a drive tool may be facilitated and a reliable driving functionality ensured.

According to a further preferred embodiment, the string device may further comprise an attachment portion for the attachment of a drive tool, preferably configured as platform device, and/or wherein the attachment portion and the guiding device are fixedly attached to one another and/or provided as an integral component. In particular, the attachment portion may support two separate portions of the guiding device. The exposing portion may be provided between these two separate portions of the guiding device.

According to a further preferred embodiment, the string device may further comprise an identification device for identification of the package, the string, the guiding device and/or the attachment portion and/or the position and/or orientation of the guiding device and/or the attachment portion and/or wherein the identification device is provided on the attachment portion and/or guiding deice. Automation may thereby be enhanced in particular automated handling and string drive processes.

According to a further preferred embodiment, the connector end pieces may have a larger size and/or diameter than the string and/or a larger size and/or diameter than the guide through opening of the package and/or than the guide through opening of the guiding device. A connector end piece arranged within the package may be configured to be blocked at said guide through opening of the package and/or at said guide through opening of the guiding device. The string may therefore remain coupled with the package even at the end of a drive process. Furthermore, the connector end piece arranged outside the package may be fixedly arranged at the distal end of the guiding device, preferably by a press fit. Unintended removal or dislocation of said connector end piece may thereby be avoided.

According to a further preferred embodiment, the package, the guiding device and/or the attachment portion are made from decomposable material. and/or may be decomposable within a time of more than 1 year, preferably more than 3 years or more than 5 years. Accordingly, the package and/or guiding device may remain in a finalized construction, such as a wall and/or pillar structure and decompose in time. The overall handling and string deployment may be facilitated.

A further aspect of the present invention refers to a robot device, preferably for a construction system according to the above description, the robot device comprising a robot with a gripper and a drive tool according to the above description and/or a string device according to the above description.

A further aspect of the present invention refers to a robot device, preferably for a construction system according to the above description, the robot device being configured for constructing a wall and/or pillar structure with a supporting portion and a covering portion for covering the supporting portion, the supporting portion being provided by solid material pieces and at least one string for jamming at least some of the solid material pieces and the covering portion comprising at least one covering device and the string and the covering device being attached to each other.

A further aspect of the present invention refers to a planning and/or operation device, preferably to a smartphone and/or a tablet, comprising an application for planning the course and/or size of a wall and/or pillar structure to be built, for receiving data from a robot device and/or for initiating the purchase and/or delivery of construction material and/or construction equipment. Such a planning and/or operation device may be part of a construction system described above.

A further aspect of the present invention refers to a method for operation of a construction system, preferably of a construction system according to the above description, comprising at least the steps of laying out a marker device for defining the contour and/or position of a wall and/or pillar structure to be built, placing a robot device close to and/or at the marker device, and constructing a wall and/or pillar structure along and/or at the marker device.

According to a preferred embodiment of the method, functional markers are placed subsequent to the laying out of the marking device.

According to a further preferred embodiment of the method, a robot device is delivered and/or activated, particularly subsequent to the laying out of the marking device or before the laying out of the marking device.

According to a further preferred embodiment of the method, a robot device follows the marking device and generates a map, particularly before constructing a wall and/or pillar structure.

According to a further preferred embodiment of the method, a robot device scans and models the environment, particularly during and/or parallel to the generation of a map.

According to a further preferred embodiment of the method, evaluation of data generated by the robot device is conducted, particularly manual and/or automated data evaluation.

According to a further preferred embodiment of the method, material packages and/or construction material is detected by the robot device.

According to a further preferred embodiment of the method, a storage area for material packages and/or construction material is enclosed.

The details and/or advantages described above with regard to the construction system likewise apply to the method for operating a construction system described above. Also, the details and/or advantages described above with regard to the drive tool, string device, robot device and/or the planning and/or operation device likewise apply to an accordingly equipped construction system.

A further aspect of the present invention refers to a construction, particularly to a wall and/or pillar structure, comprising solid material pieces and a string for jamming said solid material pieces, wherein at least some of the solid material pieces are made from basalt and/or are at least section wise covered by basalt material.

A further aspect of the present invention refers to a construction, particularly wall and/or pillar structure, comprising a supporting portion and a covering portion for covering the supporting portion, the supporting portion being provided by solid material pieces and at least one string for jamming at least some of the solid material pieces, wherein the covering portion comprises at least one covering device and wherein the string and the covering device are attached to each other and wherein the supporting portion and/or the covering portion comprise basalt material and/or dunite and/or olivine material.

According to a preferred embodiment, a plurality of solid material pieces and/or covering devices are made of basalt rock and/or dunite and/or olivine material and/or covered by basalt material and/or dunite and/or olivine material and/or exposed to air and/or wherein the basalt material and/or dunite and/or olivine material is exposed to weathering and/or configured for weathering and removing carbon dioxide from the atmosphere.

According to a preferred embodiment, at least some of the solid material pieces and/or covering devices of the covering portion are covered with powder of basalt rock and/or dunite and/or olivine material and/or microparticles of basalt rock and/or dunite and/or olivine material are exposed to the atmosphere for enhanced weathering.

According to a preferred embodiment, the basalt powder and/or dunite and/or olivine powder may have a grain size of more than 5 micro meters, more than 10 micro meters, more than 15 micro meters, more than 17.5 micro meters or more than 20 micro meters. Furthermore, the basalt powder and/or dunite and/or olivine powder may have a grain size of less than 50 micro meters, less than 40 micro meters, less than 30 micro meters, less than 25 micro meters or less than 22.5 micro meters. The optimal grain of the basalt powder and/or dunite and/or olivine powder may be 20 micro meters or about 20 micro meters. The size may refer to the mean size of the powder material.

According to a preferred embodiment, the basalt powder and/or dunite and/or olivine material may be attached to the solid material pieces and/or the covering devices of the covering portion by a slurry and/or a gel and/or a glue material.

According to a preferred embodiment, the slurry and/or gel and/or glue material is permeable for air and/or configured for dissolving, preferably for dissolving in a timeframe between 6 months and 18 months, preferably about 12 months. The weathering of the basalt material may therewith not be affected.

According to a further preferred embodiment, a basalt powder or dunite or olivine powder material may be formed to particles of a size of at least 0.5 mm, preferably more than 1 mm or more than 3 mm or more than 5 mm and/or less than 10 mm and these particles may be arranged within the supporting portion and/or the covering portion.

It may furthermore be beneficial, if the supporting portion and/or the covering portion and/or the top cover portion comprises at least one pipe, filling opening and/or tank for filling rock particles, preferably grinded rock particles, and/or a slurry and/or gel and/or glue material with rock material, more preferably for filling rock particles from basalt and/or dunite and/or olivine.

Furthermore, the at least one pipe, filling opening and/or tank may be configured for filling rock particles at an upper portion of the supporting portion and/or the covering portion and/or the top cover portion and/or for distributing the rock particles throughout the supporting portion and/or the covering portion by a stream of liquid, preferably water.

It may also be beneficial, when the supporting portion and/or the covering portion comprises a filter and/or removal opening for filtering and/or removing rock particles, particularly weathered rock particles, in a lower portion of the supporting portion and/or the covering portion, particularly for removing weathered rock particles from drainage water.

According to a further preferred embodiment, at least one sensors may be provided, preferably arranged within the supporting portion and/or the covering portion, said sensor being configured for detecting the weathering status of rock particles.

Accordingly, grinded rock particles comprising basalt and/or dunite or olivine may be inserted on the upper side of the construction into the supporting portion and/or covering portion and then distributed throughout the supporting portion and/or covering portion by a stream of water from above. The particles may fill the spaces of the covering portion without blocking fresh air from passing through the covering portion.

During a certain time period, for example, one year or three years, the particles may start to dissolve, enable weathering of the basalt rock or dunite or olivine or other materials and all residues may be washed through the covering portion. After said time period, said particles may be removed by collecting them in the lower part of the construction by applying a filter which removes these particles from drainage water.

In a preferred solution, dissolution of the particles may be achieved or enhanced through application of charcoal. Charcoal and rock powder may be mixed, for example in a relationship of 1:1, and then compressed under pressure and heat into the final particle shape. Such particles may be arranged within the supporting portion and/or covering portion.

In another preferred solution, dissolution of the particles may be achieved and/or maintained at a desired rate through application of wood pellets. Rock powder may be added to the wood during pellet production. Natural lining inside of the wood may glue the pellets together and prevent fast dissolution. The benefit for application of charcoal or wood inside of the particles may be that both are a natural source of carbon dioxide during their own weathering process. Thus, rock powder may be enclosed by a natural emitter of carbon dioxide.

A further aspect of the present invention refers to a construction, particularly to a wall and/or pillar structure, comprising solid material pieces and a string for jamming said solid material pieces, wherein at least some of the solid material pieces are made from basalt and/or are at least section wise covered by basalt material and/or dunite and/or olivine material.

A further aspect of the present invention refers to a construction, particularly wall and/or pillar structure, comprising a supporting portion and a covering portion for covering the supporting portion, the supporting portion being provided by solid material pieces and at least one string for jamming at least some of the solid material pieces, wherein the covering portion comprises at least one covering device and wherein the string and the covering device are attached to each other and wherein the supporting portion and/or the covering portion comprise basalt material and/or dunite and/or olivine material.

Furthermore, the construction system according to the present invention may be configured to provide and/or generate a construction according to any one of the above mentioned configurations.

A further aspect of the present invention refers to a method for servicing a construction according to the above description, the method comprising the steps of frequently and/or periodically applying basalt material and/or dunite and/or olivine material to the solid material pieces and/or to covering devices of a covering portion.

A further aspect of the present invention refers to a method for servicing a construction according to the above description, the method comprising the steps of frequently and/or periodically applying basalt material to the solid material pieces and/or to covering devices of a covering portion.

The features and advantages of the various embodiments of the present invention will, in the following, be described with reference to the figures.

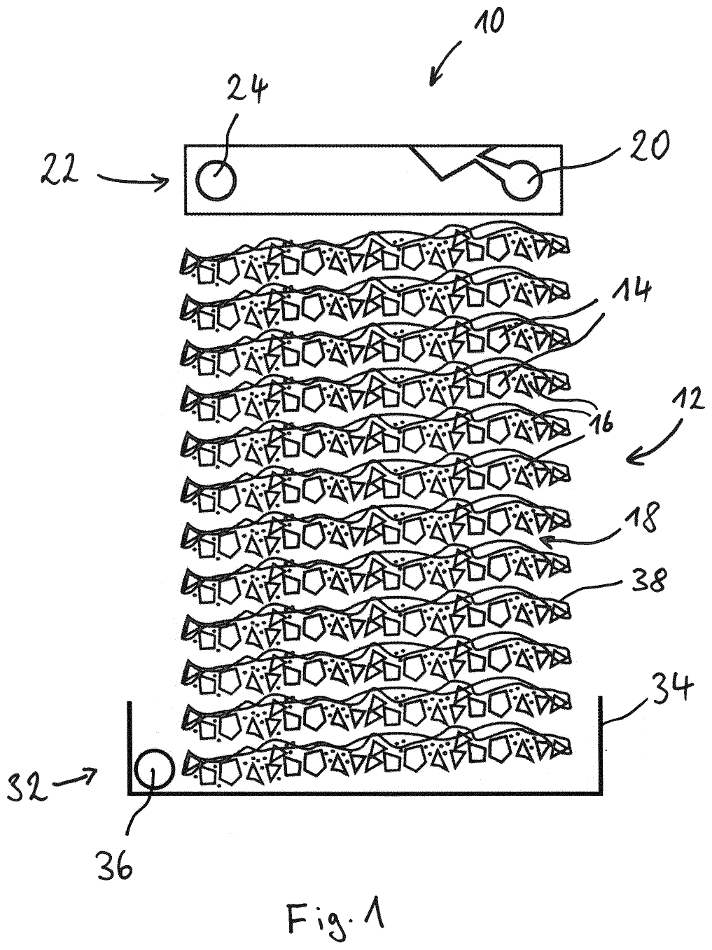

FIG. 1 shows a schematic cross sectional view of a construction for carbon capture and/or storage according to an embodiment of the present invention,

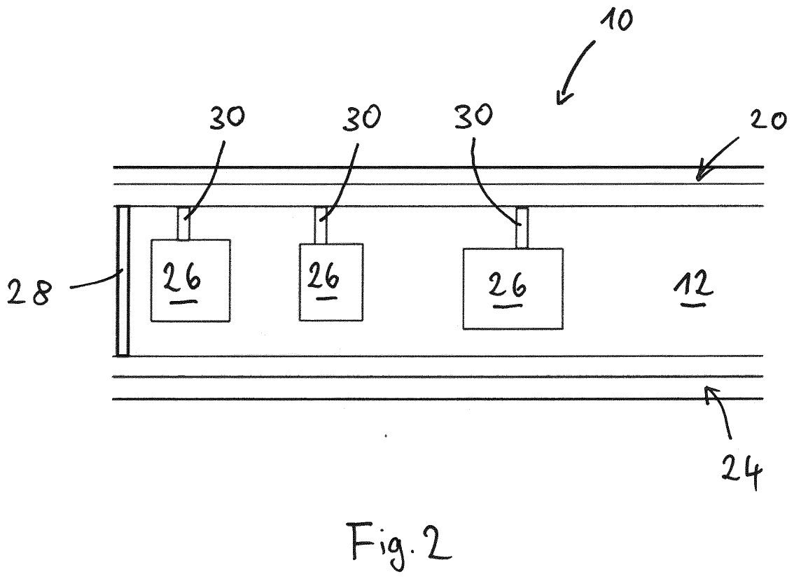

FIG. 2 shows a schematic sectional view of a top portion of a construction according to an embodiment of the present invention, and

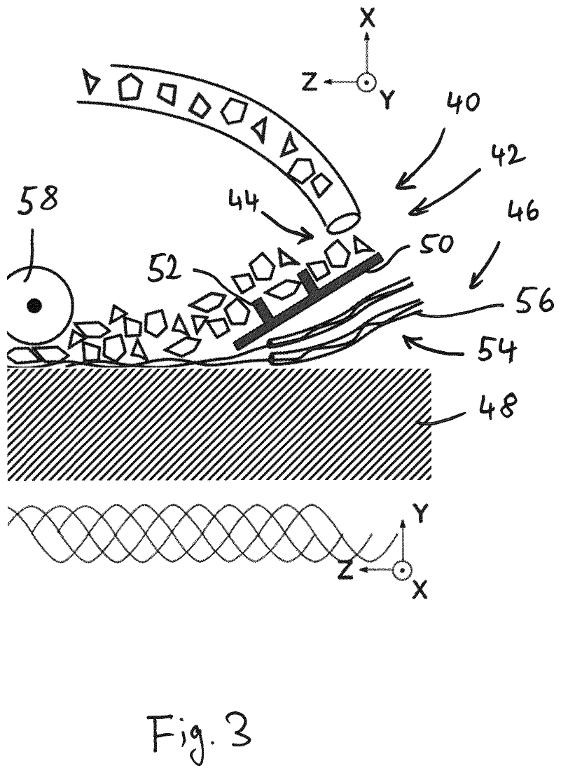

FIG. 3 shows a schematic sectional view of a construction machine and a method for generating a construction according to an embodiment of the present invention.

FIG. 1 shows a schematic cross sectional view of a construction 10 for carbon capture and/or storage according to an embodiment of the present invention. FIG. 2 shows a schematic sectional view of a top portion of a construction 10 according to an embodiment of the present invention.

The construction 10 for carbon capture and/or storage may comprise a wall and/or pillar structure 12 made from solid material pieces 14, carbon capturing material 16 arranged in storage space 18 between said solid material pieces 14.

The construction 10 may further comprise a distribution system 20 for controlled distribution of carbon capturing material 16 and/or water into said storage space 16. The distribution system 20 may provided within a top section 22 of the construction 10 and/or wall structure 12.

Furthermore, the construction 10 may comprise a fouling and/or gassing device 24, in particular a fouling and/or gassing pipe, for the controlled fouling of biological material and/or the production of CO₂, which may escape into water for moisturizing the wall. The fouling and/or gassing device 24 may likewise be arranged within a top section 22 of the construction 10 and/or wall structure 12.

With reference to FIG. 2, the fouling and/or gassing device 24 may be configured for the controlled fouling of biological material and/or the production of CO₂, which may escape and/or into water for filling of a receptacle 26 for construction material 16 and/or wherein the released CO₂ from the fouling and/or gassing device 24 may be configured to form carbonic acid within the respective water. CO₂ from the fouling and/or gassing device 24 may, for example, be released via a pipe 28 to the distribution system 20.

As further shown in FIG. 2, the distribution system 20 may be connected to the receptacles 26 via supply pipes 30. Apart from that, the distribution system 20 may have valves for guiding water into the supply pipes 30 and/or valves (not shown here) to supply water into storage space 18 between solid material pieces 14.

As further shown in FIG. 1, the construction 10 may further comprise a drainage system 32 for controlled drainage of water and/or weathered carbon capturing material 16 out of said storage space 18 and/or out of said wall and/or pillar structure 12. Said drainage system 32 may preferably comprises a basin 34 and/or reservoir below the said wall and/or pillar structure 12 and/or a pipe 36 for conveying water and/or weathered carbon capturing material out of said basin 34 and/or reservoir.

It may further be comprehended from FIG. 1 that the solid material pieces 14 are jammed by a string and/or fiber 38, particularly a basalt fiber 38.

FIG. 3 shows a schematic sectional view of a construction machine 40 and a method for generating a construction according to an embodiment of the present invention. The construction machine 40 for generating a construction 10 according to FIG. 3 may comprise a supply system 42 for continuously supplying solid bulk material 44, particularly consisting of solid material pieces 14, to a construction site 46 or a base 48 while driving and/or moving along a predefined path.

The supply system 42 may comprises a sheet ramp 50, particularly a metal sheet ramp, with a predefined widths for controlled guiding of solid bulk material 44 to a construction site 46 or base 48, wherein the sheet ramp is exchangeable for generating wall 12 structures with different widths or dimensions. The sheet ramp may be equipped with obstacles 52 placed on the path for the solid bulk material 44 to improve a uniform distribution of said solid bulk material 44 in widths-direction on the ramp 50 and subsequently on the construction site 46 or base 48.

The construction machine 40 may further comprise a feeding system 54 for feeding a string and/or a basalt fiber 38 onto a construction site 46 for a wall structure 12 and/or onto already supplied solid bulk material 44 for jamming said solid bulk material 44.

The feeding system 54 may comprise a guiding device 56 for a string and/or basalt fiber 38, preferably a guiding pipe, wherein the distal end of said guiding device may be free of any driving unit for said string or basalt fiber. The string or basalt fiber 38 may be is pushed into said guiding device 56, preferably at a defined speed and/or a controlled speed and/or by means of an airstream and/or stream of water and/or stream of slurry.

The construction machine 40 may further comprise a compacting device 58 for compacting the solid bulk material 44 deposited on a construction site 46 or base 48 and/or on layers of solid bulk material 44 already deposited, wherein said compacting device 48 is preferably configured as a rolling and/or stamping device and/or vibrating device. The compacting device 58 is may be exchangeable for different construction widths or dimensions.

As schematically indicated in the lower part of FIG. 3, a string and/or basalt fiber 38 may be deployed by an effector in a back and forth manner, preferably in a sinus formation crosswise to the feeding direction, wherein a plurality of strings and/or basalt fibers 38 may be deployed by an effector in a back and forth manner and/or on top of each other, preferably in a sinus formation crosswise to the feeding direction and/or in a sinus formation out of phase to each other.

1. A construction for carbon capture and/or storage, comprising:
a wall and/or pillar structure made from solid material pieces,
carbon capturing material arranged in storage space between said solid material pieces, and
a distribution system for controlled distribution of the carbon capturing material and/or water into said storage space.

2. The construction according to claim 1, wherein said carbon capturing material is configured for:
chemically absorbing carbon and/or carbon dioxide through exotherm reaction, and/or
mineral carbonation; or
direct air captioning of carbon and/or carbon dioxide.

3. (canceled)

4. The construction according to claim 1, wherein said carbon capturing material comprises a mineral containing Mg and/or Ca.

5. The construction according to claim 1, wherein said carbon capturing material comprises one or more of basalt, dunite, olivine, pyroxene, pyroxenoid, forsterite, monticellite, wollastonite, diopsid, and enstatite.

6. The construction according to claim 1, wherein the wall and/or pillar structure comprises at least one string for jamming said solid material pieces.

7. The construction according to claim 1, wherein the distribution system comprises a pipe and/or valves arranged on top and/or within a top portion of the wall and/or pillar structure and/or wherein the distribution system is configured for distributing rock powder and/or particles together with a water stream throughout the wall and/or pillar structure and/or wherein the distribution system is configured for controlled distribution of carbon capturing material and/or water within selected segments of the wall and/or pillar structure.

8. The construction according to claim 1, wherein the distribution system comprises at least one pipe, filling opening and/or tank for filling rock particles.

9. The construction according to claim 1, further comprising a drainage system for controlled drainage of water and/or weathered carbon capturing material out of said storage space and/or out of said wall and/or pillar structure, optionally wherein the drainage system comprises a basin and/or reservoir below the said wall and/or pillar structure and/or a pipe for conveying water and/or weathered carbon capturing material out of said basin and/or reservoir.

10. (canceled)

11. The construction according to claim 1, further comprising at least one receptacle for the controlled transformation of weathered carbon capturing material into construction material.

12. The construction according to claim 11, wherein the at least one receptacle is provided within a shell and/or within and/or on a top portion of the wall and/or pillar structure and/or wherein the receptacle is accessible from the top of the wall and/or pillar structure and/or comprises a cover and/or lid, which may be removable for access to the interior of the receptacle.

13. (canceled)

14. The construction according to claim 1, further comprising a transfer system for transferring water and/or weathered carbon capturing material out of a basin and/or reservoir below the wall and/or pillar structure into said receptacle and/or for transferring water and/or weathered carbon capturing material out of storage space directly into a receptacle for controlled transformation of weathered carbon capturing material into construction material.

15. The construction according to claim 1, further comprising a fouling and/or gassing device for the controlled fouling of biological material and/or the production of CO₂, which may escape into water for moisturizing the wall and/or into water for filling of a receptacle for construction material and/or wherein the released CO₂ from the fouling and/or gassing device is configured to form carbonic acid within the respective water.

16. (canceled)

17. Construction according to claim 1, wherein the at least one pipe, filling opening and/or tank may be configured for filling rock particles at an upper portion of the supporting portion and/or a covering portion and/or a top cover portion and/or for distributing the rock particles throughout the supporting portion and/or the covering portion by a stream of liquid.

18. (canceled)

19. (canceled)

20. A construction machine for generating a construction according to claim 1, comprising a supply system for continuously supplying a layer of solid bulk material to a construction site while driving and/or moving along a predefined path with a length of at least 5 m, wherein the supply system comprises a sheet ramp with a predefined widths for controlled guiding of solid bulk material to a construction site, wherein the sheet ramp is exchangeable for generating the wall and/or pillar structures with different widths or dimensions and/or wherein the sheet ramp is equipped with obstacles placed on the path for the solid bulk material to improve a uniform distribution of said solid bulk material in widths-direction on the ramp and subsequently on the construction site.

21. (canceled)

22. (canceled)

23. (canceled)

24. (canceled)

25. A robot device for the operation of a construction according to claim 1, comprising:
at least one sensor for measuring at least one condition of the construction selected from one or more of at least one condition of the wall pillar structure, and the carbon capturing material within the storage space between said solid material pieces;
a processing unit for processing data referring to a measured condition; and
at least one interface for transmitting the data referring to the measured condition.

26. (canceled)

27. (canceled)

28. (canceled)

29. (canceled)

30. (canceled)

31. A system comprising:
the construction of claim 1;
at least one robot device for measuring at least one condition of the construction; and an actuation device for activating and/or deactivating the distribution system for controlled distribution of carbon capturing material and/or water into said storage space and/or an actuation device for activating and/or deactivating the drainage system for controlled drainage of water and/or weathered carbon capturing material out of said storage space and/or out of said wall and/or pillar structure.

32. The system according to claim 31, further comprising an operating system system and/or wherein the robot device is connected to an Internet of Things operating system and/or a cloud based operating system.

33. A method for generating the construction according to claim 1, the method comprising the steps of:
providing a construction machine to a construction site,
continuously supplying a layer of solid bulk material to a construction site by said construction machine while driving and/or moving said construction machine along a predefined path, and
repeating the continuous supply of solid bulk material onto the previous layer in order to generate a further layer.

34. The method according to claim 33, wherein the moving and/or driving direction of the construction machine is reverted before the next layer of solid material pieces is supplied.

35. The method according to claim 33, wherein at least one string and/or basalt fiber is fed onto already supplied solid bulk material for jamming said solid bulk material; or
wherein a string and/or basalt fiber is deployed by an effector in a back and forth manner, and/or wherein a Plurality of strings and/or basalt fibers are deployed by an effector in a back and forth manner and/or on top of each other and/or in a sinus formation out of phase to each other.

36. (canceled)

37. (canceled)
